(19) United States
(12) Patent Application Publication
(10) Pub. No.: US 2025/0289107 A1
(43) Pub. Date: Sep. 18, 2025

(54) GAS SPRING-POWERED FASTENER DRIVER

(71) Applicant: MILWAUKEE ELECTRIC TOOL CORPORATION, Brookfield, WI (US)

(72) Inventors: Travis W. Leathrum, Milwaukee, WI (US); David A. Bierdeman, New Berlin, WI (US)

(21) Appl. No.: 19/078,846

(22) Filed: Mar. 13, 2025

Related U.S. Application Data
(60) Provisional application No. 63/564,556, filed on Mar. 13, 2024.
(60) Provisional application No. 63/643,519, filed on May 7, 2024.
(60) Provisional application No. 63/766,050, filed on Mar. 3, 2025.

(51) Int. Cl. B25C 5/13

(52) U.S. Cl. CPC B25C 5/13

(57) ABSTRACT

A powered fastener driver including a driver blade movable from a top-dead-center (TDC) position toward a bottom-dead-center (BDC) position for driving a fastener into a workpiece, a nosepiece through which the fastener is driven into the workpiece that is configured to guide the driver blade and the fastener into the workpiece, and a lifting assembly for providing torque to move the driver blade from the (BDC) position toward the TDC position. The lifting assembly includes a rotary lifter for engaging the driver blade to move the driver blade toward the (TDC) position. The rotary includes a body having a central aperture, a flange radially extending from the body that defines an outer radial profile configured to contact the driver blade to return the driver blade from the BDC position toward the TDC position, and a non-rotating mounting shaft coupled to the central aperture to rotatably support the rotary lifter thereon.

### CROSS-REFERENCE TO RELATED APPLICATIONS

This application claims priority to U.S. Provisional Patent Application No. 63/766,050 filed on Mar. 3, 2025, U.S. Provisional Patent Application 63/643,519 filed on May 7, 2024, and U.S. Provisional Patent Application 63/564,556 filed on Mar. 13, 2024, the entire contents of all of which are incorporated herein by reference.

### FIELD OF THE DISCLOSURE

The present disclosure relates to powered fastener drivers, and more specifically to gas spring-powered fastener drivers.

### BACKGROUND OF THE DISCLOSURE

There are various fastener drivers known in the art for driving fasteners (e.g., nails, tacks, staples, etc.) into a workpiece. These fastener drivers operate utilizing various means known in the art (e.g., compressed air generated by an air compressor, electrical energy, a flywheel mechanism, etc.) to drive a driver blade from a top-dead-center position toward a bottom-dead-center position to strike a fastener and drive the fastener into a workpiece.

### SUMMARY OF THE DISCLOSURE

The present disclosure provides, in one aspect, a powered fastener driver including a driver blade movable from a top-dead-center (TDC) position toward a bottom-dead-center (BDC) position for driving a fastener into a workpiece, a nosepiece through which the fastener is driven into the workpiece that is configured to guide the driver blade and the fastener as the driver blade drives the fastener into the workpiece, and a lifting assembly for providing torque to move the driver blade from the (BDC) position toward the TDC position. The lifting assembly includes a rotary lifter for engaging the driver blade to move the driver blade toward the (TDC) position. The rotary includes a body having a central aperture, a flange radially extending from the body that defines an outer radial profile configured to contact the driver blade to return the driver blade from the BDC position toward the TDC position, and a non-rotating mounting shaft coupled to the central aperture to rotatably support the rotary lifter thereon.

The present disclosure provides, in another aspect, a powered fastener driver including a driver blade movable from a top-dead-center (TDC) position toward a driven or bottom-dead-center (BDC) position for driving a fastener into a workpiece, a nosepiece through which the fastener is driven into the workpiece, the nosepiece configured to guide the driver blade and the fastener as the driver blade drives the fastener into the workpiece, and a lifting assembly for providing torque to move the driver blade from the (BDC) position toward the TDC position. The lifting assembly includes a rotary lifter configured to selectively engage the driver blade to move the driver blade toward the (TDC) position. The rotary lifter includes a body having a central aperture and a flange radially extending from the body that defines an outer radial profile configured to contact the driver blade to return the driver blade from the BDC position toward the TDC position. The flange includes plurality of rollers radially disposed about the body to define the outer radial profile. The powered fastener driver further includes a non-rotating mounting shaft coupled to the central aperture to rotatably support the rotary lifter thereon. A last roller of the plurality of rollers is shaped differently than a remainder of the plurality of rollers.

The present disclosure provides, in another aspect, a powered fastener driver including a driver blade movable from a top-dead-center position (TDC) toward a driven or bottom-dead-center (BDC) position for driving a fastener into a workpiece, a nosepiece through which the fastener is driven into the workpiece that is configured to guide the driver blade and the fastener as the driver blade drives the fastener into the workpiece, and a lifting assembly for providing torque to move the driver blade from the BDC position toward the TDC position. The lifting assembly includes a rotary lifter configured to selectively engage the driver blade to move the driver blade toward the TDC position. The rotary lifter includes a body and a plurality of protrusions extending from the body. The powered fastener driver also includes a transmission configured to provide torque to the rotary lifter. The transmission is directly coupled to the body of the lifter via the plurality of protrusions.

The present disclosure provides, in yet another aspect, a powered fastener driver including a driver blade movable from a top-dead-center (TDC) position toward a driven or bottom-dead-center (BDC) position for driving a fastener into a workpiece, and a lifting assembly for providing torque to move the driver blade from the BDC position toward the TDC position. The lifting assembly includes a rotary lifter configured to selectively engage the driver blade to move the driver blade toward the TDC position. The rotary lifter includes a cylindrical body rotatable about a rotational axis, a flange extending radially outward from the cylindrical body, a plurality of pins disposed about a circumference of the body, each pin of the plurality of pins extending from opposite sides of the flange, a plurality of rollers disposed upon the respective pins and on opposite sides of the flange, and a cantilevered support shaft extending from the body along the rotational axis. The cantilevered support shaft is coupled for co-rotation with the cylindrical body. The powered fastener driver also includes a transmission configured to provide torque to the rotary lifter via the cantilevered support shaft.

The present disclosure provides, in yet another aspect, a powered fastener driver including a driver blade moveable from a top-dead-center (TDC) position to a driven or bottom-dead-center (BDC) position for driving a fastener into a workpiece. The driver blade includes a lowermost drive tooth having a flat portion. The powered fastener driver also includes a drive unit for providing torque to move the driver blade from the BDC position to toward the TDC position that includes a support shaft, and a rotary lifter engageable with the driver blade. The lifter is configured to receive torque from the drive unit in a rotational direction for returning the driver blade from the BDC position toward the TDC position. The lifter includes a plurality of lift pins and a roller rotatably supported on one of the lift pins for selective engagement with the flat portion of the lowermost drive tooth, and a kickout arrangement defined between the roller and the lowermost drive tooth. The kickout arrangement is configured to permit limited movement of the lifter relative to the support shaft between a first position and a second position. The lifter is in the first position relative to the support shaft when returning the driver blade from the BDC position toward the TDC position. The kickout arrangement permits the lifter to rotate relative to the support shaft opposite the rotational direction from the first position to the second position to form a clearance between the driver blade and the roller after the driver blade reaches the TDC position.

The present disclosure provides, in yet another aspect, a powered fastener driver including a driver blade movable from a top-dead-center position (TDC) toward a driven or bottom-dead-center (BDC) position for driving a fastener into a workpiece, the driver blade having a plurality of pins, a nosepiece through which the fastener is driven into the workpiece, the nosepiece configured to guide the driver blade and the fastener as the driver blade drives the fastener into the workpiece, and a lifting assembly for providing torque to move the driver blade from the BDC position toward the TDC position. The lifting assembly includes a rotary lifter configured to selectively engage the driver blade to move the driver blade toward the TDC position. The rotary lifter includes a plurality of teeth disposed about a circumference of the body for sequentially contacting the pins on the driver blade to return the driver blade from the BDC position toward the TDC position.

Other features and aspects of the disclosure will become apparent by consideration of the following detailed description and accompanying drawings.

### BRIEF DESCRIPTION OF THE DRAWINGS

FIG. 1 is perspective view of a powered fastener driver.

FIG. 2 is another perspective view of the powered fastener driver of FIG. 1, with portions of a housing removed to show a driving assembly and a lifting assembly of the powered fastener driver.

FIG. 3 is a partial cross-sectional view of the powered fastener driver of FIG. 1, taken along section line 3-3 in FIG. 1.

FIG. 4 is a perspective view of a portion of the lifting assembly and a driver blade.

FIG. 5 is a top view of the lifting assembly and driver blade of FIG. 4.

FIG. 6 is a side view of the lifting assembly and driver blade of FIG. 4.

FIG. 7 is a partial cross-sectional view of the lifting assembly of FIG. 4, taken along section line 7-7 in FIG. 4.

FIG. 8 is a partial perspective view of a portion of a lifting assembly in accordance with another embodiment of the present disclosure.

FIG. 9 is a perspective view of a portion of a lifting assembly and a driver blade in accordance with yet another embodiment of the present disclosure.

FIG. 10 is a partial cross-sectional view of the lifting assembly of FIG. 9, taken along section line 10-10 in FIG. 9.

FIG. 11 is a partial cross-sectional view of a portion of a lifting assembly in accordance with yet another embodiment of the present disclosure.

FIG. 12 is a side view of a powered fastener driver in accordance with yet another embodiment of the present disclosure, with portions of a housing removed to show a lifting assembly and a portion of a driving assembly of the powered fastener driver.

FIG. 13 is a schematic illustrating a portion of the lifting assembly of FIG. 12.

FIG. 14 is a perspective view of a portion of the rotary lifter and a driver blade of the powered fastener driver of FIG. 12.

FIG. 15 is a cross-sectional view of the portion of the rotary lifter and the driver blade of FIG. 14, taken along section line 15-15 in FIG. 14.

FIG. 16 is a cross-sectional view of a portion of a lifting assembly in accordance with yet another embodiment of the present disclosure.

FIG. 17 is a cross-sectional view of a portion of a rotary lifter in accordance with yet another embodiment of the present disclosure.

FIG. 18 is a perspective view of a portion of a rotary lifter and a driver blade in accordance with yet another embodiment of the present disclosure.

FIG. 19 is a perspective view of a rotary lifter of the lifting assembly of FIG. 18.

FIG. 20 is a cross-sectional view of the portion of the rotary lifter and the driver blade of FIG. 18, taken along section line 20-20 in FIG. 18.

FIG. 21 is a perspective view of a portion of a rotary lifter in accordance with yet another embodiment of the present disclosure.

FIG. 22 is a cross-sectional view of a rotary lifter of the lifting assembly of FIG. 21, taken along section line 22-22 in FIG. 21.

FIG. 23 is a perspective view of a portion of a rotary lifter in accordance with yet another embodiment of the present disclosure.

FIG. 24 is a plan view of a portion of a rotary lifter in accordance with yet another embodiment of the present disclosure.

FIG. 25 is a perspective view of a portion of a rotary lifter in accordance with yet another embodiment of the present disclosure.

FIG. 26 is a cross-sectional view of a portion of the rotary lifter of FIG. 25, taken along section line 26-26 in FIG. 25.

FIG. 27 is a plan view of a rotary lifter in accordance with yet another embodiment of the present disclosure.

FIG. 28 is a perspective view of a rotary lifter in accordance with yet another embodiment of the present disclosure.

FIG. 29 is a cross-sectional view of the rotary lifter of FIG. 29, illustrated with a portion of a driver blade, and taken along section line 29-29 in FIG. 28.

FIG. 30 is a perspective view of a portion of the driver blade utilizing an integrated frame for supporting the rotary lifter in accordance with another embodiment of the present disclosure.

FIG. 31 is a perspective view of the integrated frame of FIG. 30 with portions removed for clarity.

FIG. 32 is a zoomed-in perspective view of a flat portion on a tooth of a driver blade in accordance with another embodiment of the present disclosure.

FIG. 33 is a cross-sectional view of a lifter assembly in a first rotational position in relation to a driver blade in accordance with another embodiment of the present disclosure.

FIG. 34A is another cross-sectional view of the lifter assembly of FIG. 33 in an intermediate position.

FIG. 34B is a zoomed-in view of FIG. 34A illustrating the lifter assembly in the intermediate position.

FIG. 35 is another cross-sectional view of the lifter assembly of FIG. 33 in a second rotational position in relation to the driver blade.

FIG. 36 is a zoomed-in view of FIG. 35 illustrating the lifter assembly in the second rotational position.

FIG. 37 is a perspective view of a portion of a rotary lifter and a driver blade in accordance with yet another embodiment of the present disclosure.

FIG. 38 is a top view of the rotary lifter and driver blade of FIG. 37.

FIG. 39 is a detailed, cross-sectional view of a transmission in accordance with another embodiment of the present disclosure.

FIG. 40 is a perspective view of the transmission of FIG. 39.

FIG. 41 is a perspective view of a rotary lifter in accordance with another embodiment of the present disclosure.

FIG. 42 is a cross-sectional view of a powered fastener driver according to an embodiment of the present disclosure, with portions of a housing removed to show a driving assembly of the powered fastener driver.

FIG. 43 is a perspective view of a rotary lifter in accordance with another embodiment of the present disclosure.

FIG. 44 is perspective view of the rotary lifter of FIG. 43 with portions removed for clarity.

FIG. 45 is a rear view of the rotary lifter of FIG. 44 to show a latching assembly.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

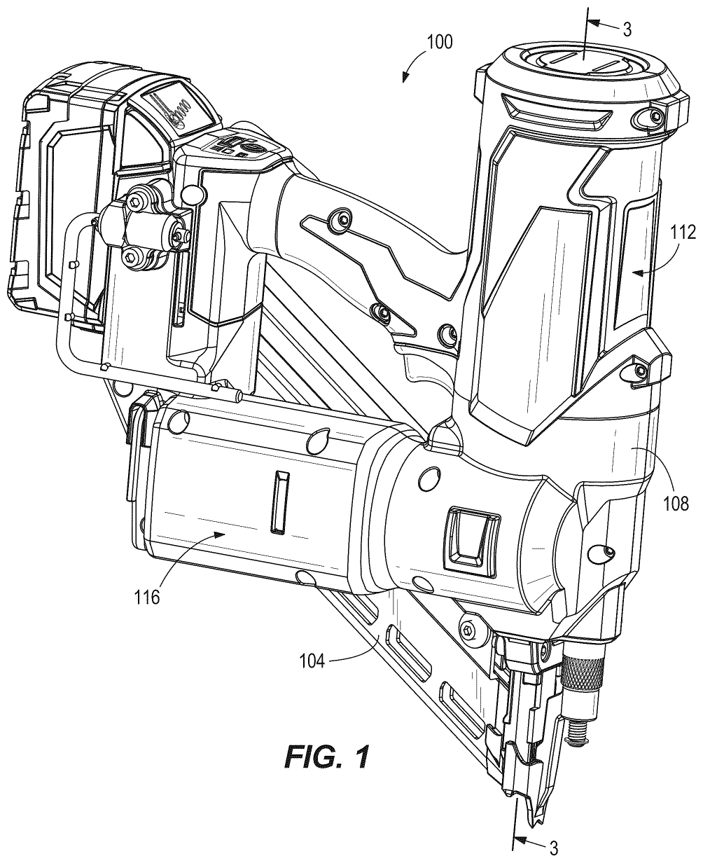

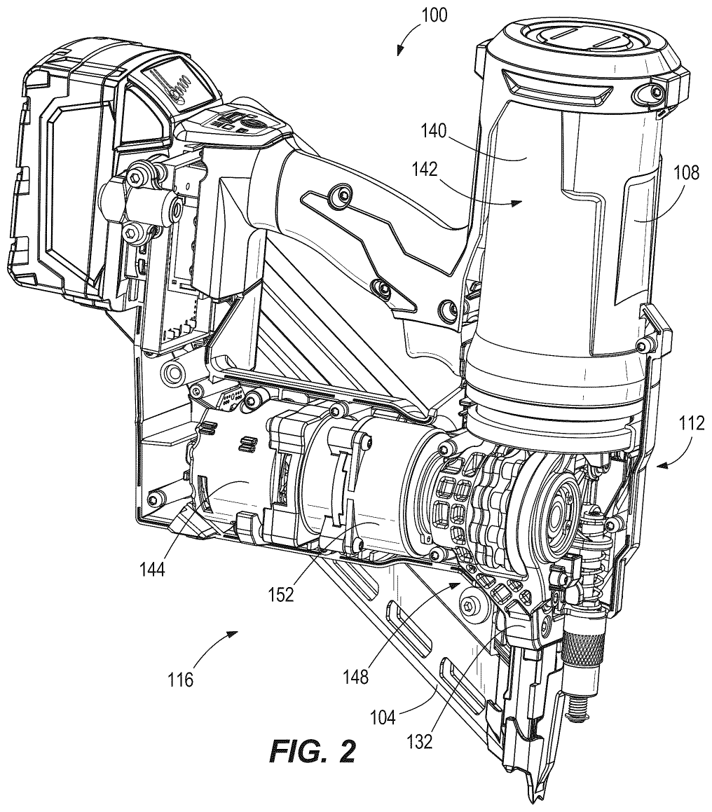

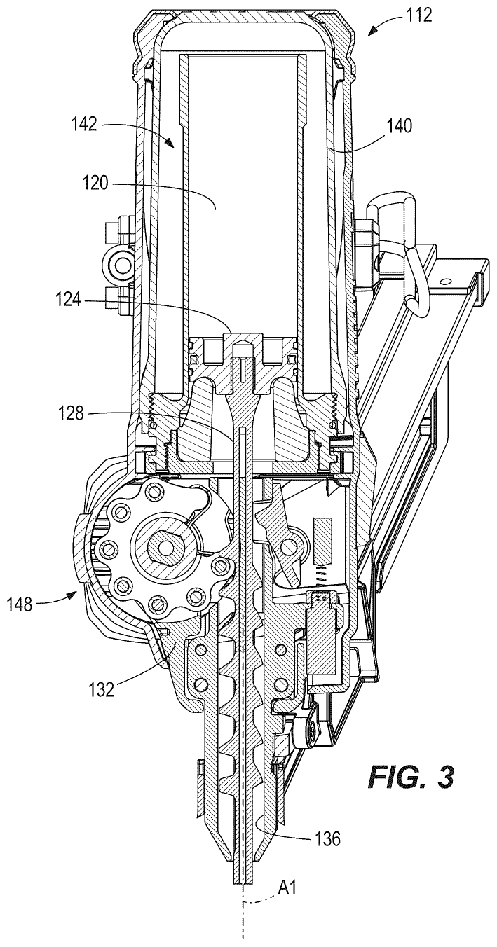

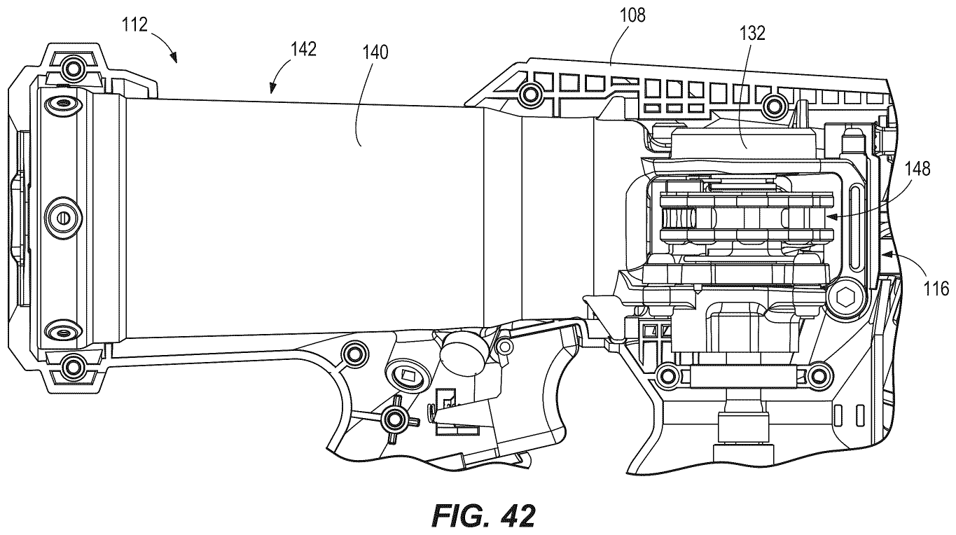

FIGS. 1-3 illustrate a gas spring-powered fastener driver 100 in accordance with the present disclosure. The fastener driver 100 is operable to drive fasteners (e.g., nails, tacks, staples, etc.) that are held within a magazine 104 into a workpiece (not shown). The fastener driver 100 includes a housing 108, illustrated as a two-piece clamshell housing, supporting a driving assembly 112 operable to drive a fastener and a lifting assembly 116 operable to reset the driving assembly 112, such that the fastener driver 100 can drive another fastener. The driving assembly 112 includes an inner cylinder 120 and a movable piston 124 positioned within the inner cylinder 120. The piston 124 is movable within the inner cylinder 120 between a ready or top-dead-center (TDC) position (not shown) and a driven or bottom-dead-center position (BDC; FIG. 3). A driver blade 128 is coupled to the piston 124 and movable therewith along a driving axis A1. The fastener driver 100 further includes a frame 132 disposed within the housing 108 to aid in supporting the driving assembly 112 and the lifting assembly 116. In some embodiments, the frame 132 may also support the inner cylinder 120 and an outer cylinder 140, as described in further detail below. The fastener driver 100 also includes a nosepiece 136 coupled to the magazine 104, and the nosepiece 136 sequentially receives fasteners from the magazine 104 to be driven into the workpiece. The nosepiece 136 guides each fastener as the fastener is driven into the workpiece by the driver blade 128 of the driving assembly 112. The fastener driver 100 does not require an external source of air pressure to drive a fastener, but rather includes a storage chamber cylinder or outer cylinder 140 of pressurized gas in fluid communication with the inner cylinder 120. In the illustrated embodiment, the outer cylinder 140 encompasses the inner cylinder 120, and together the outer cylinder 140 and the inner cylinder 120 form a compression chamber 142. In some embodiments, such as in FIG. 42, the outer cylinder 140 is integrally formed with the frame 132. As the driver blade 128 and the piston 124 move toward the ready position due to the lifting assembly 116, the air within the compression chamber (e.g., above the piston 124) is compressed, thereby increasing an amount of pressure acting on the piston 124. The lifting assembly 116 includes a motor 144 operatively coupled to a rotary lifter 148. The rotary lifter 148 is selectively engageable with the driver blade 128, as will be discussed in further detail herein, to move the driver blade 128 and the piston 124 toward the ready position. In the illustrated embodiment, a transmission 152, such as a planetary transmission, is disposed between the motor 144 and the rotary lifter 148 to transmit rotational power or torque from the motor 144 to the rotary lifter 148.

In operation, the lifting assembly 116 provides torque generated by the electric motor 144 via the transmission 152 to the rotary lifter 148 to rotate the rotary lifter 148. Rotation of the rotary lifter 148 moves the driver blade 128 from the driven position toward the ready position. Movement of the driver blade 128, and thus the piston 124, to the ready position compresses the gas contained within the compression chamber 142. Thus, the lifting assembly 116 provides torque to the rotary lifter 148 to move the driver blade 128 to the ready position, thereby increasing an amount of pressure acting on the piston 124. To drive a fastener that has been provided to the nosepiece 136 from the magazine 104, the driver blade 128 is released from the ready position and moves toward the driven position due to the pressure of the gas acting on the piston 124. The compression chamber 142 is a sealed environment and therefore acts as a gas spring on the piston 124. As the driver blade 128 moves toward the BDC position, the driver blade 128 contacts the fastener to drive the fastener into the workpiece, and the fastener is guided into the workpiece by the nosepiece 136. Further details regarding certain structures of the fastener driver 100 are given below.

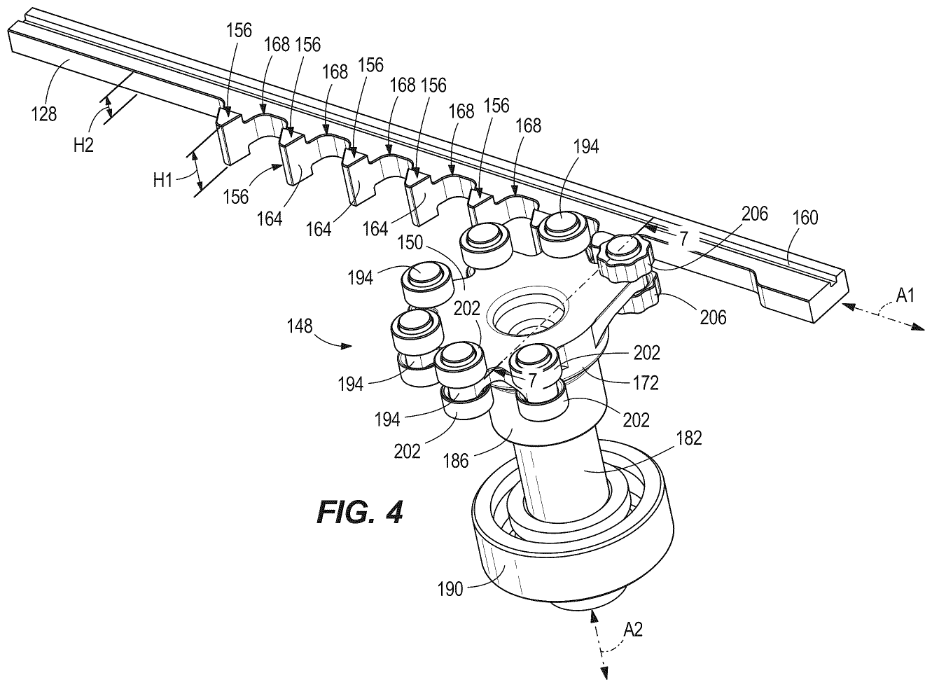

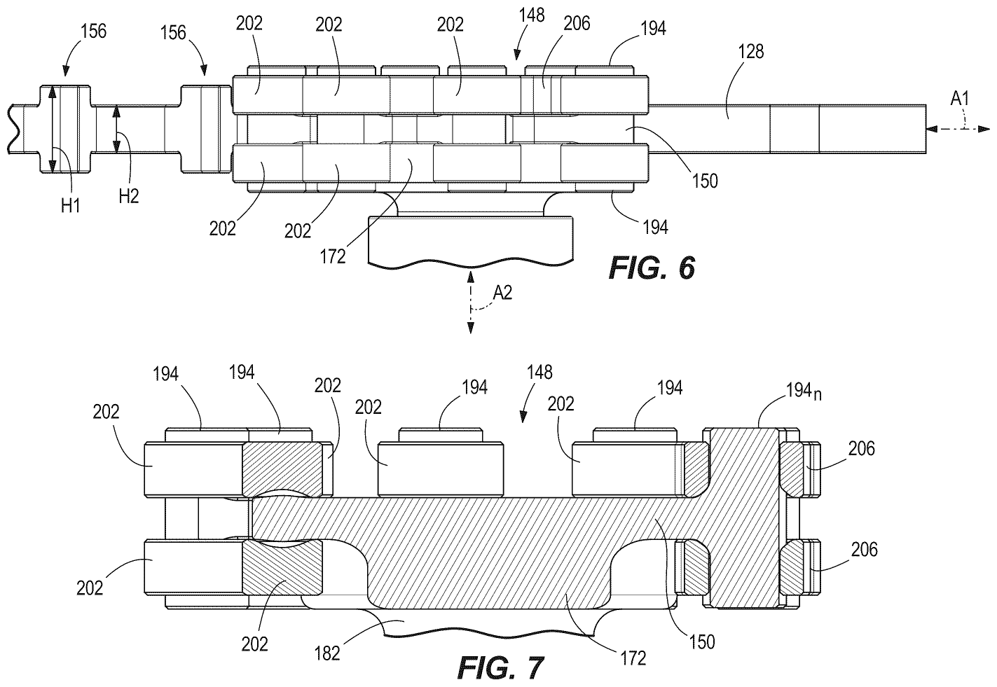

FIGS. 4-7 illustrate further details of the rotary lifter 148 and the driver blade 128 in accordance with an embodiment of the present disclosure. As previously mentioned, the rotary lifter 148 selectively engages with the driver blade 128 to move the driver blade 128 along the driving axis Al from the driven position toward the ready position. To accomplish the selective engagement, the driver blade 128 includes a plurality of lift teeth 156 extending laterally therefrom. The driver blade 128 has a length that is parallel to the driving axis A1, and the lift teeth 156 extend from the driver blade 128 transversely to the driving axis A1. In the illustrated embodiment, the driver blade 128 further includes a slot 160 extending along its length parallel to the driving axis A1 and may receive a corresponding protrusion (not shown) of the nosepiece therein to align the driver blade 128 and the driving axis A1. Each of the plurality of lift teeth 156 includes a lifting surface 164 engageable with the rotary lifter 148. The lifting surface 164 in the illustrated embodiment has a height H1 that is greater than a height H2 of the driver blade 128. In other embodiments, each lifting surface has a height that is equal to a height of the driver blade. As will be described in greater detail herein, the height H1 of the lifting surface 164 aids the driver blade 128 in engaging the rotary lifter 148. In the illustrated embodiment, a plurality of recesses 168 is disposed between adjacent teeth of the plurality of lift teeth 156 to provide clearance for engagement between the plurality of the lift teeth 156 and the rotary lifter 148.

With continued reference to FIGS. 4-7, the rotary lifter 148 includes a body 172 and a support shaft 182 extending from the body 172 to be operatively coupled to the transmission 152 and to support the rotary lifter 148. In the illustrated embodiment, the support shaft 182 extends centrally from body 172 and extends along a rotational axis A2 of the rotary lifter 148. In other words, the support shaft 182 is cantilevered from the body 172. A first bearing 186 is coupled to the support shaft 182 adjacent to the body 172, and a second bearing 190 is coupled to the support shaft 182 distal from the body 172. The support shaft 182 is coupled to the transmission adjacent to the second bearing 190. The first bearing 186 and the second bearing 190 may further be coupled to the housing 108 of the fastener driver 100 or to the frame 132 to secure the rotary lifter 148 relative to the housing 108 while allowing for operation of the lifting assembly 116. In the illustrated embodiment, the support shaft 182 and the rotary lifter 148 are integrally formed. However, in other embodiments, the support shaft 182 may be coupled to the body 172 of the rotary lifter 148.

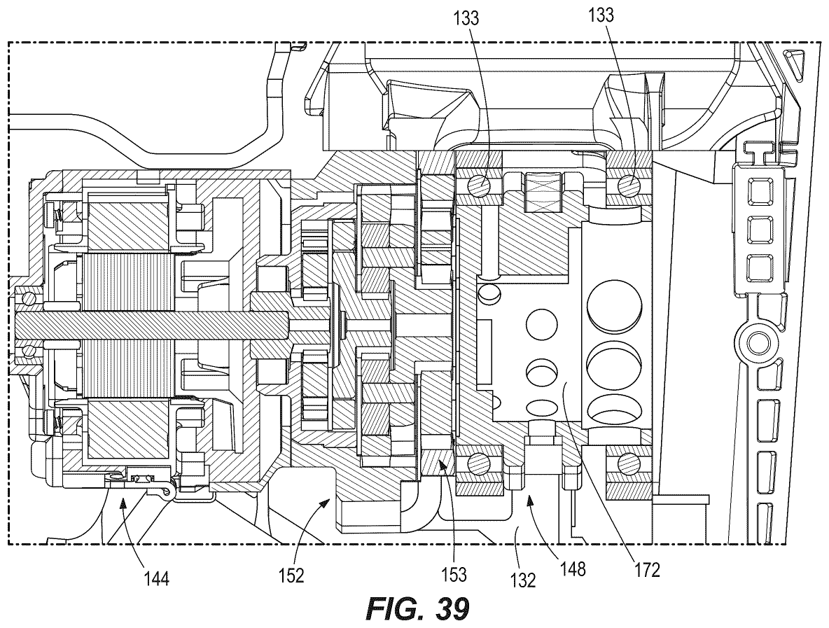

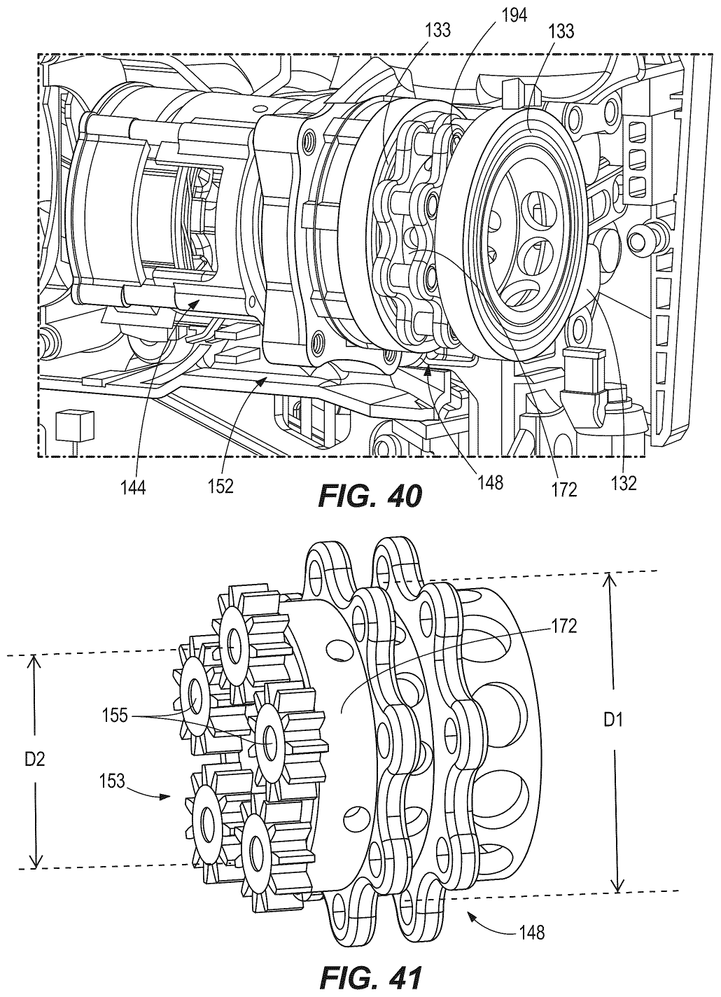

With respect to FIGS. 39-41, in some embodiments, a last stage 153 of the planetary transmission 152 can be integrated with the body 172 of the lifter 148. The last stage 153 can be coupled to the body 172 of the lifter 148 via a plurality of pins 155 extending from the last stage 153 of the planetary transmission 152 and coupled to the body 172 of the lifter 148. With this configuration, the last stage 153 of the planetary transmission 152 can rotatably drive the lifter 148 directly instead of rotatably driving a separate output shaft to rotatably drive the lifter 148. This arrangement eliminates parts and materials that are otherwise needed to transmit torque through a smaller diameter shaft between a traditional transmission and rotary lifter. In some embodiments, the body of the lifter 172 can include a pitch circle diameter (PCD) D1 coincident with the radial spacing of the pins 194 (FIG. 40) of 46 millimeters and the last stage 153 of the planetary transmission 152 can have a PCD D2 coincident with the radial spacing of the pins 155 of 30 millimeters. In such an arrangement, a ratio of D1/D2 is about 1.53:1. In other embodiments, the ratio of D1/D2 is less than 1.5:1 to about 1:1. In yet other embodiments, the frame 132 includes one or more bearings 133 for rotatably supporting the body 172 of the lifter 148.

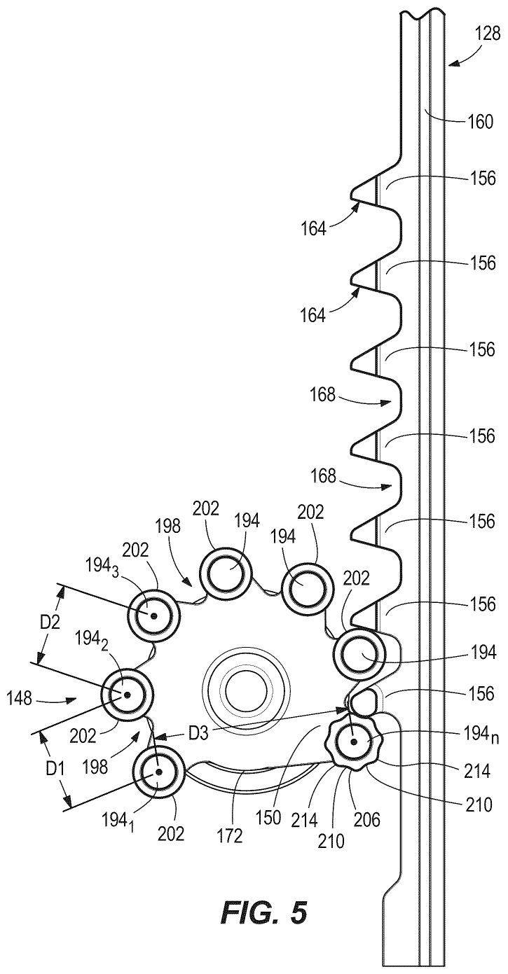

With continued reference to FIGS. 4-7, the body 172 of the rotary lifter 148 is generally circular in cross-section when viewed along the rotational axis A2 (FIG. 5). In other words, the body 172 is cylindrical. The rotary lifter 148 also includes a flange 150 extending radially outward from the body 172. A plurality of pins 194 is disposed about a circumference of the body 172 and, in the illustrated embodiment, each pin of the plurality of pins 194 extends from opposite sides of the flange 150. Each of the plurality of pins 194 extends parallel to the rotational axis A2 of the rotary lifter (e.g., has a length that is parallel to the rotational axis A2). Referring to FIG. 5, the illustrated rotary lifter 148 includes “n” pins 194, with “n” being an integer. The plurality of pins 194 is spaced about the circumference of the body 172 such that a distance D1 between a first pin 194₁ and a second pin 194₂ is substantially similar to a distance D2 between the second pin 194₂ and a third pin 194₃, etc. However, a distance D3 between the n^{th} pin 194ₙ, and the first pin 194₁ is greater than the distance between the remainder of the pins 194. As illustrated in FIGS. 4-7, the flange 150 may include a plurality of recesses 198 disposed between adjacent pins 194 to provide clearance for the lift teeth 156 to engage the rotary lifter 148 without interfering with the body 172 of the rotary lifter 148. Furthermore, in the illustrated embodiment, the plurality of pins 194 is integrally formed with the flange 150 and the body 172 of the rotary lifter 148 (FIG. 7).

Referring still to FIGS. 4-7 and as previously mentioned, each pin 194 of the plurality of pins 194 extends from opposite sides (i.e., both above and below) of the flange 150. A plurality of rollers 202 is supported upon the plurality of pins 194, such that each pin 194 includes a roller 202 both above and below the flange 150. Thus, the rotary lifter 148 includes two rows of rollers 202 on the opposite sides of the flange 150. The rollers 202 may be bearings assemblies, bushings, or other rolling elements. The rollers 202 are operable to contact the lifting surfaces 164 of the plurality of lift teeth 156 when the rotary lifter 148 engages with the driver blade 128 to reduce friction and other loading forces that are experienced between the rotary lifter 148 and the lift teeth 156. In the illustrated embodiment, the n^{th} pin 194ₙ includes a different roller than the plurality of 202 rollers disposed upon the remainder of the pins 194. The n^{th} pin 194ₙ includes a socket roller 206 having a non-cylindrical outer peripheral surface. The socket roller 206 is defined by an undulating outer peripheral surface that includes a plurality of engagement sections 210. In other words, the socket roller 206 includes a plurality of radial protrusions 214 that define valleys therebetween, and the valleys form the engagement sections 210. The engagement sections 210 are sized to receive a portion of a lift tooth therein (FIG. 5).

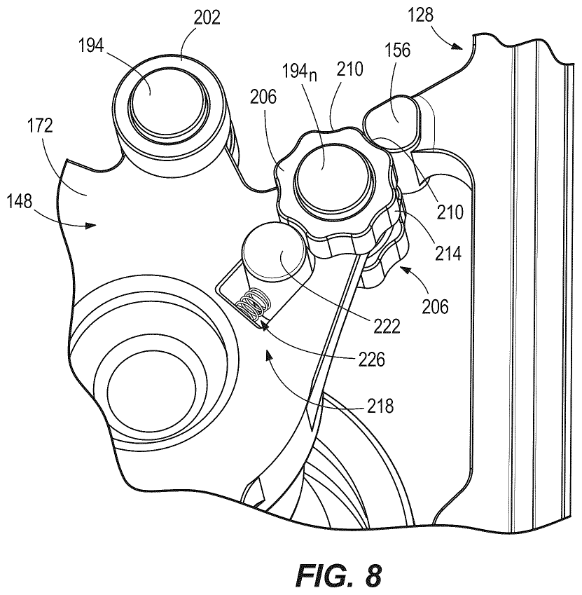

With reference to FIG. 8, in some embodiments, the rotary lifter 148 includes a detent 218 coupled to the body 172 and positioned to act upon the socket roller 206. The detent 218 of the illustrated embodiment is a shaft 222 aligned with the n^{th} pin 194ₙ and biased into engagement with the socket roller 206. The shaft 222 is biased toward an engagement section 210 of the socket roller 206 to limit rotation of the socket roller 206 about the pin 194, thereby aligning another engagement section 210 of the socket roller 206 with the lift tooth 156. Alignment of an engagement section 210 with the lift tooth 156 aids in meshing the rotary lifter 148 with the driver blade 128. Furthermore, the detent 218 limits rotation of the socket roller 206 when not engaged with a lift tooth 156 of the driver blade 128. In the illustrated embodiment, the detent 218 includes the shaft 222 that extends parallel to the pin 194 of the rotary lifter 148 and is biased by a biasing spring 226 towards the rotary lifter 148 into engagement with both socket rollers 206 (e.g., the socket rollers 206 above and below the body 172 of the rotary lifter 148 on the ^{nth} pin 194ₙ). In other embodiments, the detent 218 may include two shafts, such that each shaft is biased into engagement with one of the socket rollers 206. In yet other embodiments, the detent 218 may be formed as a pair of ball detents biased into engagement with the socket rollers 206 or may be formed as a leaf spring or multiple leaf springs shaped to engage the engagement section 210 of the socket rollers 206.

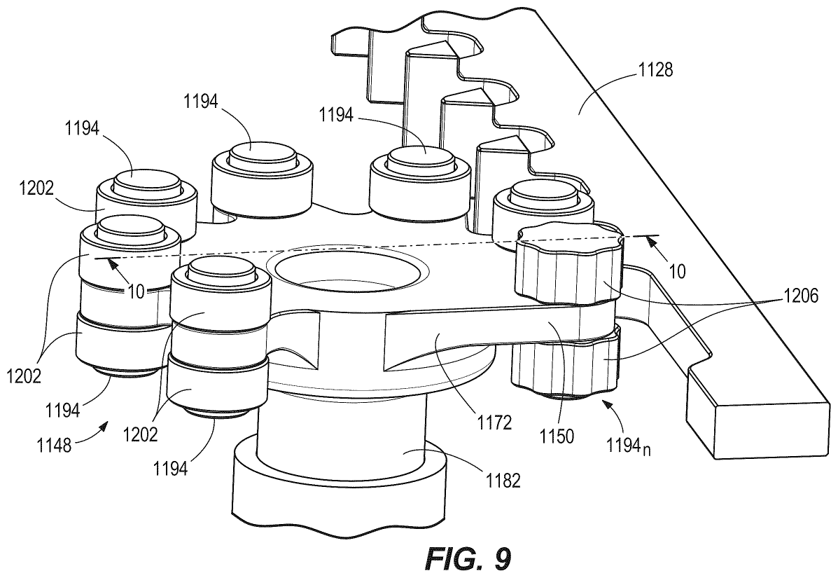

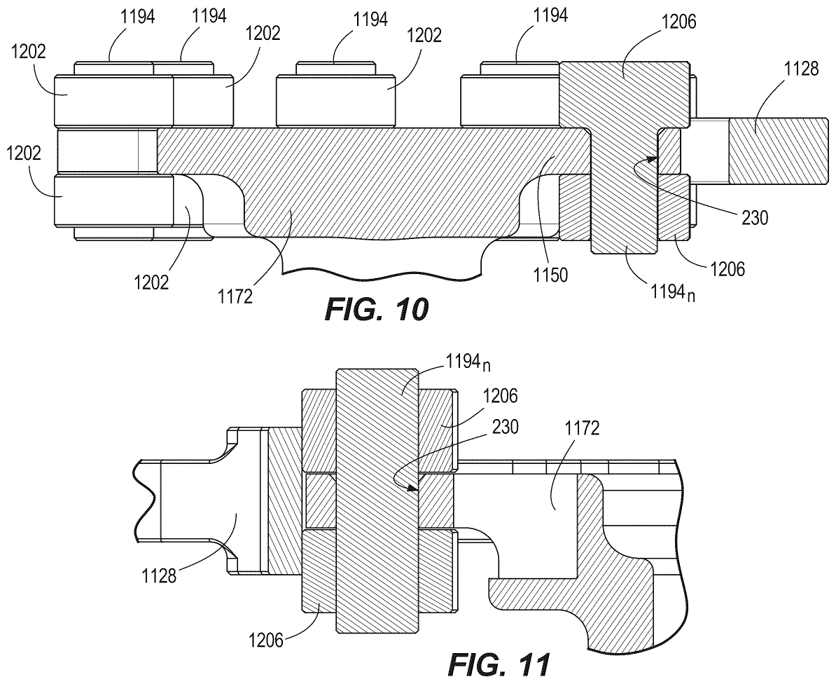

While the plurality of pins 194 of the embodiment of FIGS. 4-7 are integrally formed with the flange 150 and the body 172 of the rotary lifter, FIG. 9-11 illustrate embodiments of a rotary lifter 1148, with like parts having like reference numbers plus “1000” and the following differences explained below. Unlike the rotary lifter 148, the pins 1194 are formed separately from the rotary lifter 1148 and coupled to the flange 1150 of the rotary lifter 1148. The flange 1150 may include a plurality of apertures 230, and the plurality of pins 1194 may be disposed within the plurality of apertures 230. In the embodiment of FIGS. 9 and 10, the n^{th} pin 1194ₙ includes an integrally formed socket roller 1206 forming a head of the pin 194. A second socket roller 1206 is coupled to the pin 1194ₙ on an opposite side of the body 1172 of the rotary lifter 1148 as the integrally formed socket roller 1206 to secure the pin 1194ₙ within the aperture 230 of the body 1172. In the embodiment of FIG. 11, the n^{th} pin 1194ₙ in formed independently of both socket rollers 1206.

In operation, the rotary lifter 148 is supported within the fastener driver 100 by the cantilevered support shaft 182. The first and second bearings 186, 190 couple the rotary lifter 148 to the housing 108, and the support shaft 182 is secured to the transmission 152 to receive torque therefrom. The electric motor 144 provides torque to the transmission 152 which, in turn, provides torque to the rotary lifter 148 via the support shaft 182. The torque provided to the rotary lifter 148 induces rotation of the body 172 of the rotary lifter 148 causing the rotary lifter 148 to sequentially engage the lift teeth 156 of the driver blade 128 to move the driver blade 128 toward the TDC position. In the illustrated embodiment, the plurality of rollers 202 engage with the lifting surfaces 164 of the plurality of the lift teeth 156, and the socket roller 206 engages a last of the lift teeth 156. In some embodiments, a rotary lifter may not include rollers, and the plurality of pins of the rotary lifter may engage with the lifting surfaces of the lift teeth. The rotary lifter 148 of the illustrated embodiment includes rollers 202 disposed on either side of the flange 150, and each roller 202 engages with the lifting surfaces 164. Thus, forces acting on the rotary lifter 148 from each lift tooth 156 of the driver blade 128 are shared between sides of the body 172 of the rotary lifter 148. As previously mentioned, the height H1 of each lifting surface 164 is greater than the height H2 of the driver blade 128. The height H1 of the lifting surface 164 is such that the lifting surface 164 is engageable with the rollers 202 both above and below the flange 150 of the rotary lifter 148 simultaneously to distribute or share the forces acting on the rotary lifter 148, and more specifically the dual rollers 202 in each row of pins 194.

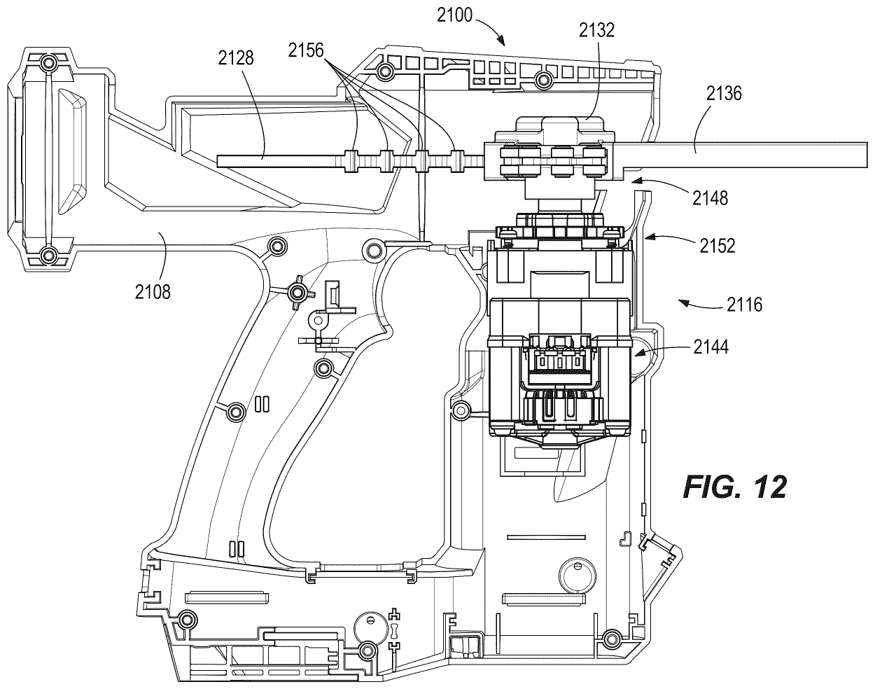

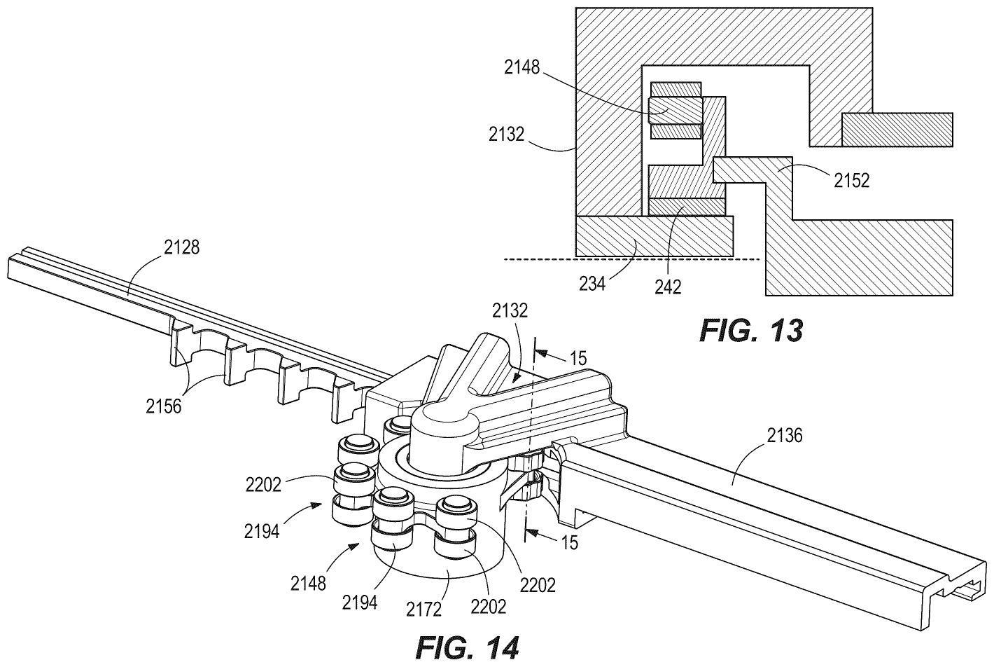

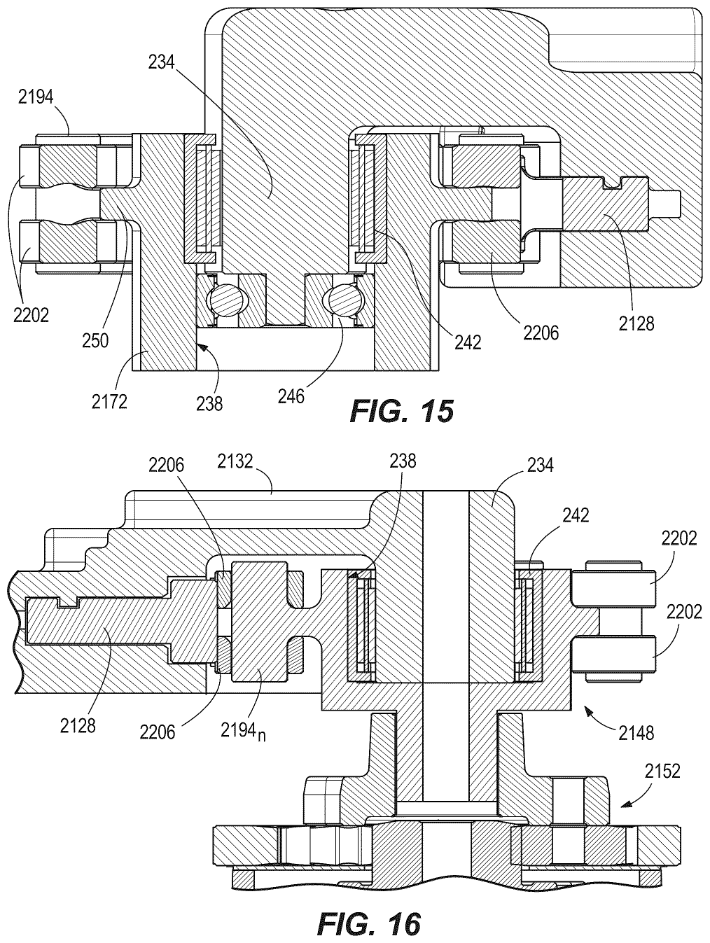

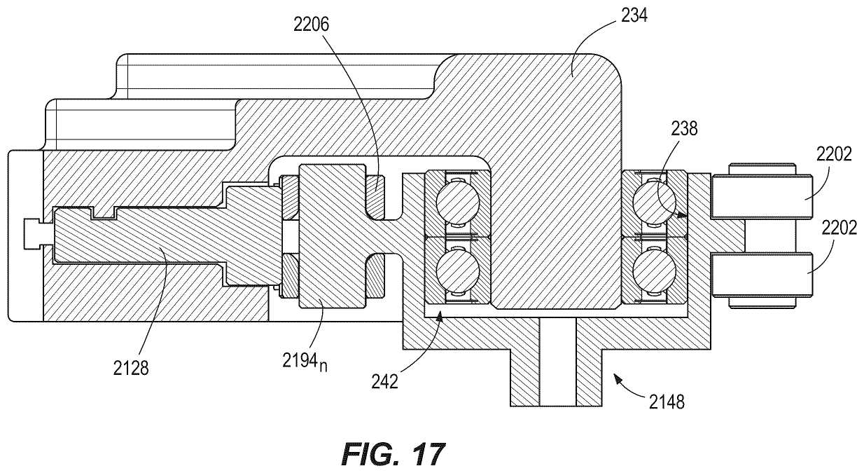

FIGS. 12-17 illustrate another embodiment of a fastener driver 2100 in accordance with the present disclosure, with like parts having like reference numbers plus “2000” and the following differences explained below. Rather than the rotary lifter 148 including an integrated, cantilevered support shaft 182 to support the rotary lifter 148 and to receive torque from the transmission 152, the rotary lifter 2148 is supported by the frame 2132 of the powered fastener driver 2100 and does not include a support shaft. In the illustrated embodiment, the rotary lifter 2148 is supported by the nosepiece 2136 (FIG. 14). The nosepiece 2136 includes a non-rotating mounting shaft 234 extending therefrom, and the rotary lifter 2148 includes a central aperture 238 extending through the body 2172. In other embodiments, the non-rotating mounting shaft 234 may be coupled to and extend from the frame 2132, on which the inner and outer cylinders 2120, 2140 are supported, instead of the nosepiece 2136. Furthermore, in other embodiments, the rotary lifter 2148 may include a centrally located blind bore, rather than the central aperture 238. The mounting shaft 234 extends into the central aperture 238 and is coupled to the body 2172 of the rotary lifter 2148 via a bearing assembly 242. The body 2172 of the rotary lifter 2148 is then directly coupled to the transmission 2152 to receive torque therefrom. Referring to the schematic of FIG. 13, the body 2172 may be splined to the transmission 2152 (and more specifically, to a final-stage planetary carrier) to receive only torque loads from the transmission 2152. The bearing assembly 242 rotatably couples the body 2172 to the frame 2132 of the fastener driver 2100 to support the rotary lifter 2148. The bearing assembly 242 of the illustrated embodiment is a needle bearing assembly (FIG. 16). In the embodiment of FIG. 15, the needle bearing assembly 242 is a first bearing assembly and a ball bearing assembly 246 is also disposed between the mounting shaft 234 and the body 2172 of the rotary lifter 2148. Furthermore, in some embodiments, the bearing assembly 242 may include a pair of ball bearing assemblies (FIG. 17). Similar to the rotary lifter including the cantilevered support shaft, the rotary lifter 2148 includes a plurality of pins 2194 supporting a plurality of rollers 2202 that sequentially engage with the lift teeth 2156 of the driver blade 2128. In the illustrated embodiment, the body 2172 includes a radially extending flange 250 having opposite sides from which the plurality of pins 2194 extend, with the two rows of rollers 2202 being disposed on the opposite sides of the flange 250.

In some embodiments, the radially extending flange 250 defines an outer radial profile defined by each of the plurality of pins 2194 and the plurality of rollers 2202.

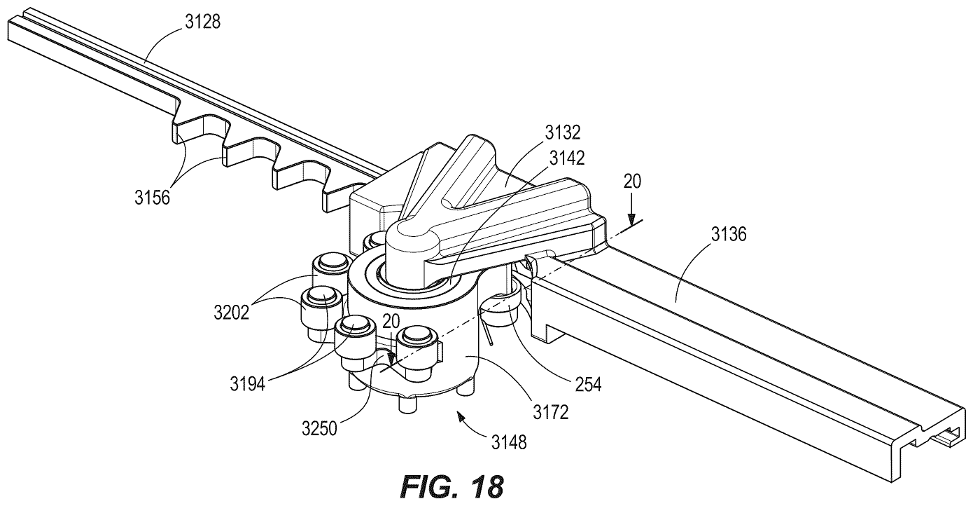

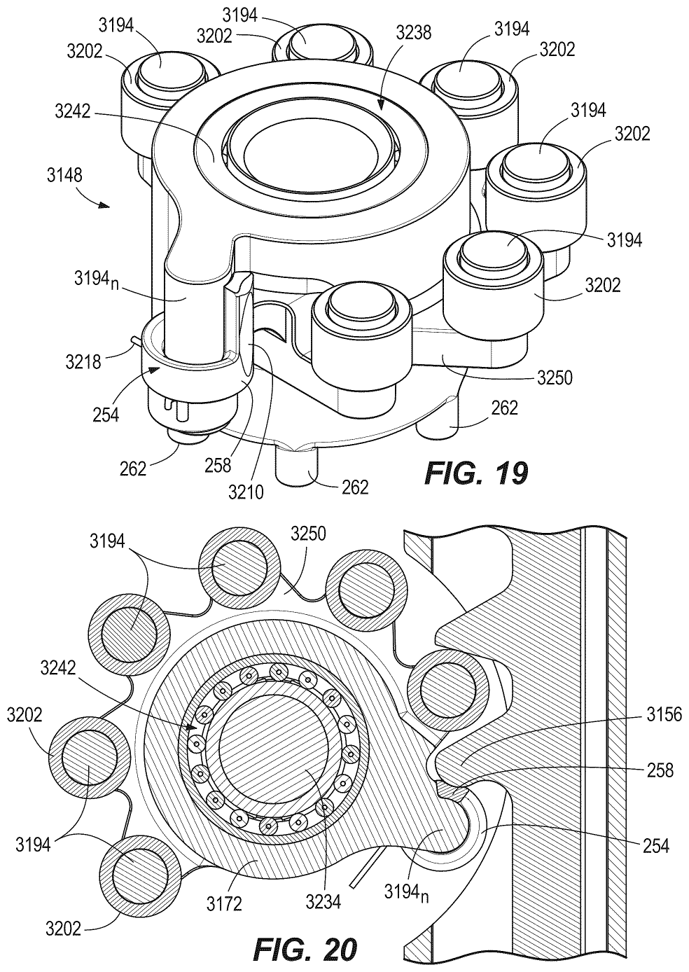

FIGS. 18-20 illustrate yet another embodiment of a rotary lifter 3148 in accordance with the present disclosure, with like parts having like reference numbers plus “3000” and the following differences explained below. Similar to the rotary lifter 2148 described above, the rotary lifter 3148 includes a central aperture 3238 in which a bearing assembly 3242 is disposed to couple the rotary lifter 3148 to the fastener driver 3100. Unlike the rotary lifter 2148, the rotary lifter 3148 includes a plurality of pins 3194 cantilevered from the radially extending flange 3250 of the body 3172. In other words, the flange 3250 extends from the cylindrical body 3172 of the rotary lifter 3148, and the plurality of pins 3194 extends only from a single side from the flange 3250. In some embodiments, the rotary lifter 3148 may include a plurality of pins 3194 extending both above and below the radially extending flange 3250. The plurality of pins 3194 still each supports a plurality of rollers 3202 that is engageable with the driver blade 3128. The n^{th} pin 3194ₙ, however, does not support a socket roller. Rather, the n^{th} pin 3194ₙ supports an alignment ring 254. The alignment ring 254 includes an arm 258 extending therefrom along the pin 3194ₙ to engage a lift tooth 3156. The arm 258 includes a recess forming an engagement section 3210. Thus, the alignment ring 254 and the arm 258 are similar to the previously described socket roller, but with only a single engagement section 3210. In some embodiments, the n^{th} pin 3194ₙ may include a socket roller disposed thereon, rather than the alignment ring 254. The alignment ring 254 may further include a biasing spring, illustrated as a torsion spring 3218, to rotationally bias the alignment ring 254 toward a position in which the engagement section 3210 is aligned with a portion of the lift tooth 3156. Furthermore, the rotary lifter 3148 includes a plurality of protrusions 262 extending from the body 3172 to couple the rotary lifter 3148 to the transmission 3152, rather than utilizing a splined connection.

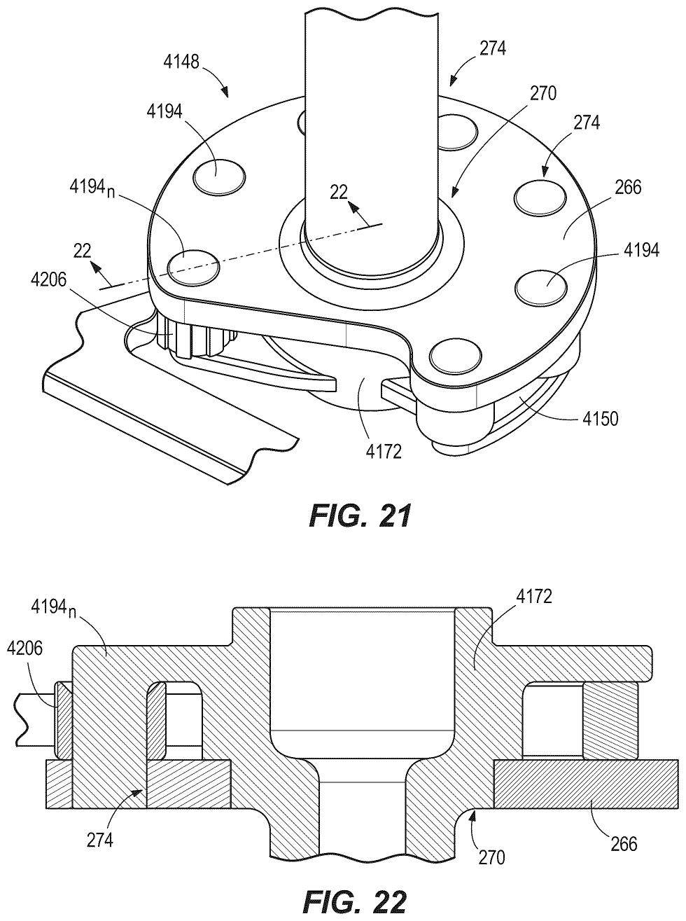

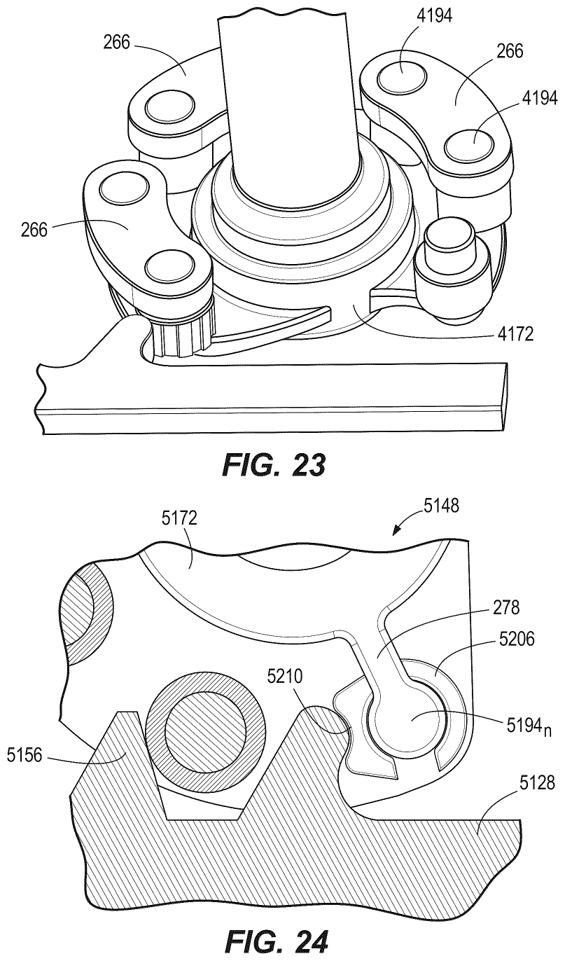

FIGS. 21-23 illustrate yet another embodiment of a rotary lifter 4148 in accordance with the present disclosure, with like parts having like reference numbers plus “4000” and the following differences explained below. The rotary lifter 4148 includes a body 4172 and a flange 4150 extending radially outwardly from the body 4172. A plurality of pins 4194 are disposed about a circumference of the body 4172. However, unlike the embodiment of FIGS. 4-7, the pins 4194 are cantilevered from a single side of the flange 4150. A plurality of rollers 4202 are supported upon the respective pins 4194, and the n^{th} pin 4194ₙ includes a socket roller 4206. The rotary lifter 4148 further includes a load plate 266 coupled to the pins 4194. The load plate 266 includes a central aperture 270 through which the body 4172 of the rotary lifter 4148 extends and a plurality of pin apertures 274 spaced about the load plate 266 to receive the respective pins 4194 therein. The load plate 266 distributes mechanical loading forces amongst the pins 4194 during a lifting operation. In the embodiment of FIG. 23, the load plate 266 is formed as a plurality of load plates 266 that couple adjacent pins 4194. While the pins 4194 are illustrated as being integrally formed with the flange 4150 of the rotary lifter 4148, in other embodiments, the pins 4194 may be separate from the rotary lifter 4148 and coupled to the flange 4150.

FIG. 24 illustrates yet another embodiment of a rotary lifter 5148 in accordance with the present disclosure, with like parts having like reference numbers plus “5000” and the following differences explained below. Unlike the rotary lifter 4148, the rotary lifter 5148 does not include a load plate. The rotary lifter 5148, however, includes a radial arm 278 extending from the body 5172 of the rotary lifter 5148. The radial arm 278 couples the n^{th} pin 5194ₙ to the body 5172 and, in the illustrated embodiment, is integrally formed with both the pin 5194ₙ and the body 5172. The radial arm 278 extends from the n^{th} pin 5194ₙ opposite the flange 5150, and the socket roller 5206 is coupled to the n^{th} pin 5194ₙ between the flange 5150 and the radial arm 278. Furthermore, in the embodiment of FIG. 24, the socket roller 5206 is C-shaped and includes only a single engagement section 5210. The socket roller 5206 is rotatable about the n^{th} pin 5194ₙ such that the engagement section 5210 meshes with the lift teeth 5156 of the driver blade 5128. In operation, the radial arm 278 functions similarly to the load plate of the previous embodiment to distribute mechanical loading forces experienced by the n^{th} pin as the rotary lifter 5148 engages the driver blade 5128. However, the radial arm 278 distributes only the mechanical loading forces on the n^{th} pin 5194ₙ to the body 5172, rather than distributing loading forces amongst the remaining pins.

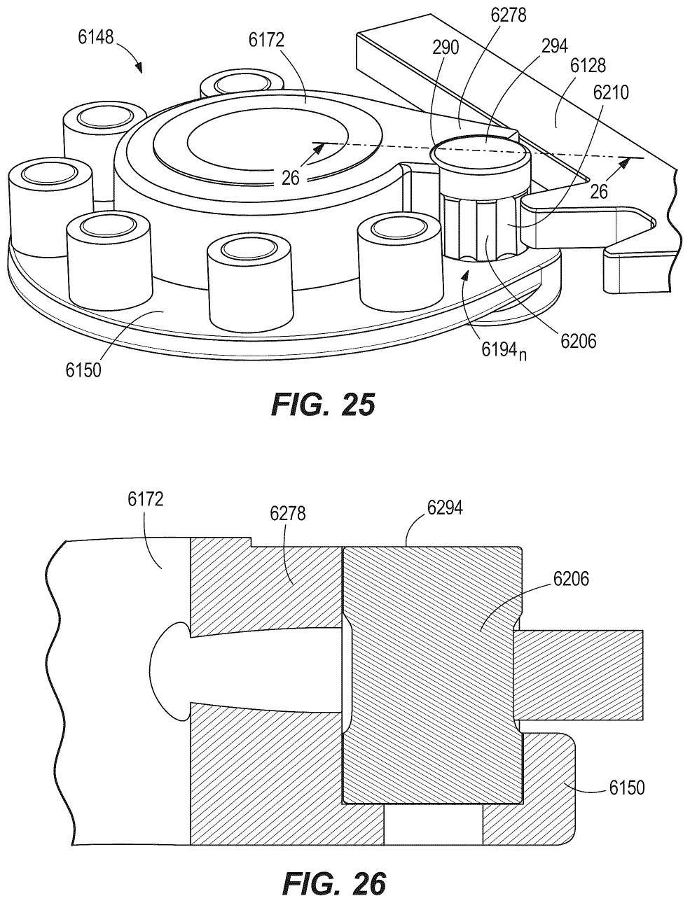

FIGS. 25 and 26 illustrate yet another embodiment of a rotary lifter 6148 in accordance with the present disclosure, with like parts having like reference numbers plus “6000” and the following difference explained below. Rather than the radial arm 6278 being integrally formed with the body 6172 and the n^{th} pin 6194ₙ, the radial arm 6278 extends from the body 6172 of the toward the n^{th} pin 6194ₙ but is not integrally formed with the n^{th} pin 6194ₙ. Instead, the socket roller 6206 is formed as a cap that encompasses the n^{th} pin 6194ₙ, and the radial arm 6278 includes an arcuate recess 290 in which a portion of the socket roller 6206 is received. More particularly, the socket roller 6206 includes a plurality of engagement sections 6210 and a cylindrical cap 294. The cylindrical cap 294 is disposed within the arcuate recess 290 and abuts against the radial arm 6278 to support the socket roller 6206 and thus the n^{th} pin 6194ₙ. As such, the radial arm 6278 absorbs bending loads applied to the pin 6194ₙ (via socket roller 6206) by the engaged lift teeth 6156 when the drive blade 6128 is being returned toward the TDC position. Thus, the radial arm 6278, via the socket roller 6206, distributes mechanical loading forces from the n^{th} pin to the body of the rotary lifter 6148.

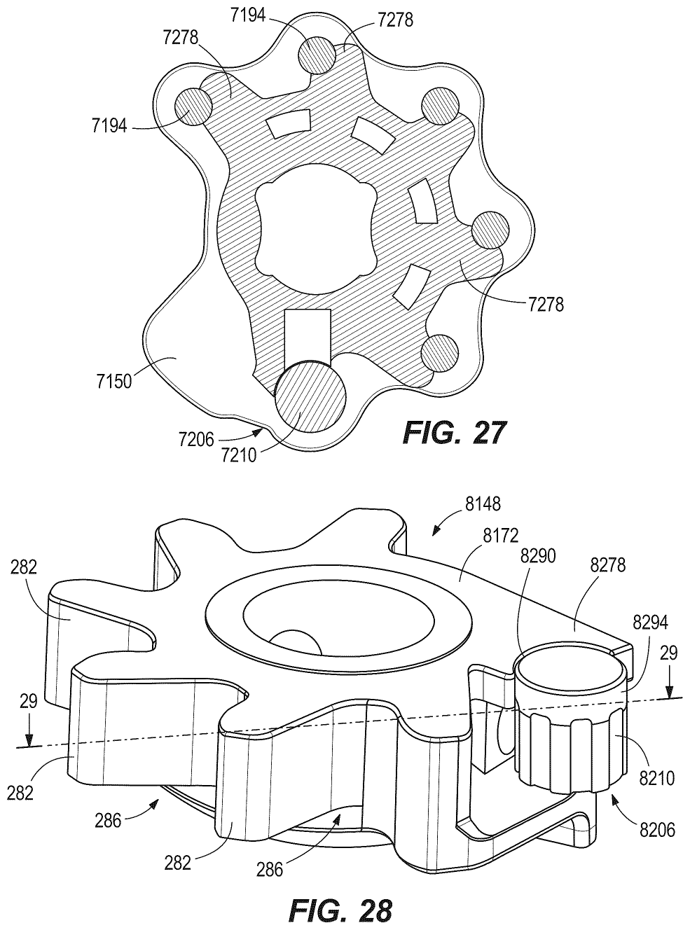

FIG. 27 illustrates yet another embodiment of a rotary lifter 7148 in accordance with the present disclosure, with like parts having like reference numbers plus “7000” and the following differences explained below. Similar to the previous rotary lifter 6148, the rotary lifter 7148 includes a radial arm 7278 that abuts against the cylindrical cap 7294 of the socket roller 7206 to distribute mechanical loading forces experienced by the n^{th} pin 7194ₙ. Unlike the previously described rotary lifter 6148, however, the rotary lifter 7148 includes a plurality of radially extending arms 7278. Each radially extending arm 7278 abuts against a pin 7194 to support the pin 7194 and distribute mechanical loading forces.

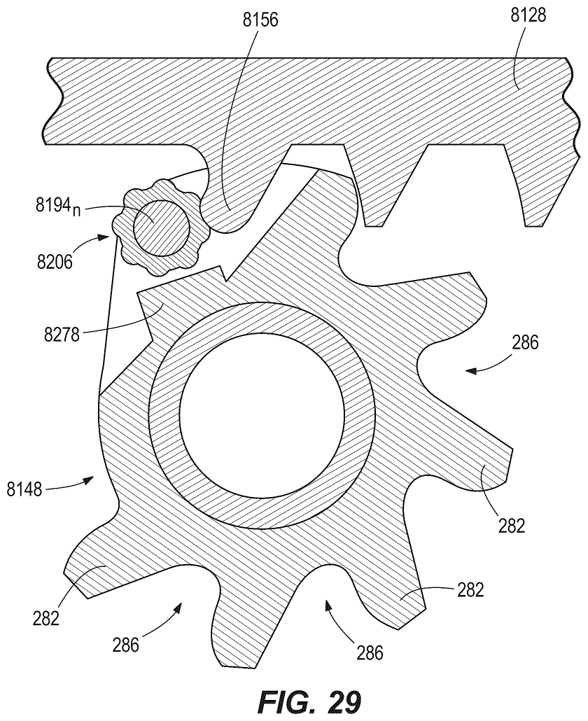

FIGS. 28 and 29 illustrate yet another embodiment of a rotary lifter 8148 in accordance with the present disclosure, with like parts having like reference numbers plus the number “8000” and the following differences explained below. Rather than including a plurality of pins like the previously described rotary lifters, the rotary lifter 8148 includes a plurality of lugs 282 integrally formed with the body 8172. The lugs 282 define recesses 286 therebetween to provide clearance for the lift teeth 8156 of the driver blade 8128. Each of the lugs 282 engages with the lift teeth 8156 as the driver blade 8128 is moved toward the top dead center position. The rotary lifter 8148, however, does include a pin 8194ₙ that corresponds to the n^{th} pin of the previous embodiments. The pin 8194ₙ supports a socket roller 8206 that is similar to the socket roller 6206. Thus, the socket roller 8206 includes a plurality of engagement sections 8210 and a cylindrical cap 8294. The socket roller 8206 is disposed upon and encompasses the pin 8194ₙ. The socket roller 8206 is rotatable about the pin 8194ₙ, and a radially extending arm 8278 extends from the body 8172 of the rotary lifter 8148 to support the socket roller 8206 and thus the pin 8194ₙ. The radially extending arm 8278 includes an arcuate recess 8290 that abuts against the cylindrical cap 8294. As such, the radially extending arm 8278 absorbs bending loads applied to the pin 8194ₙ (via socket roller 8206) by the engaged lift teeth 8156 when the drive blade 8128 is being returned toward the TDC position.

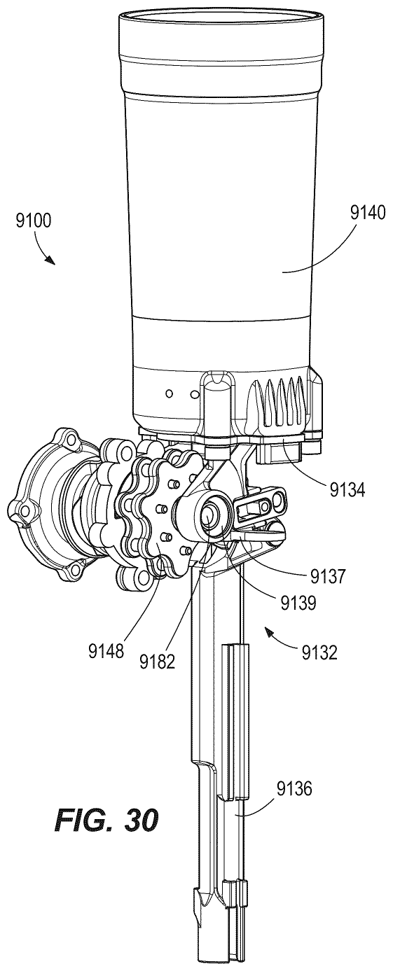

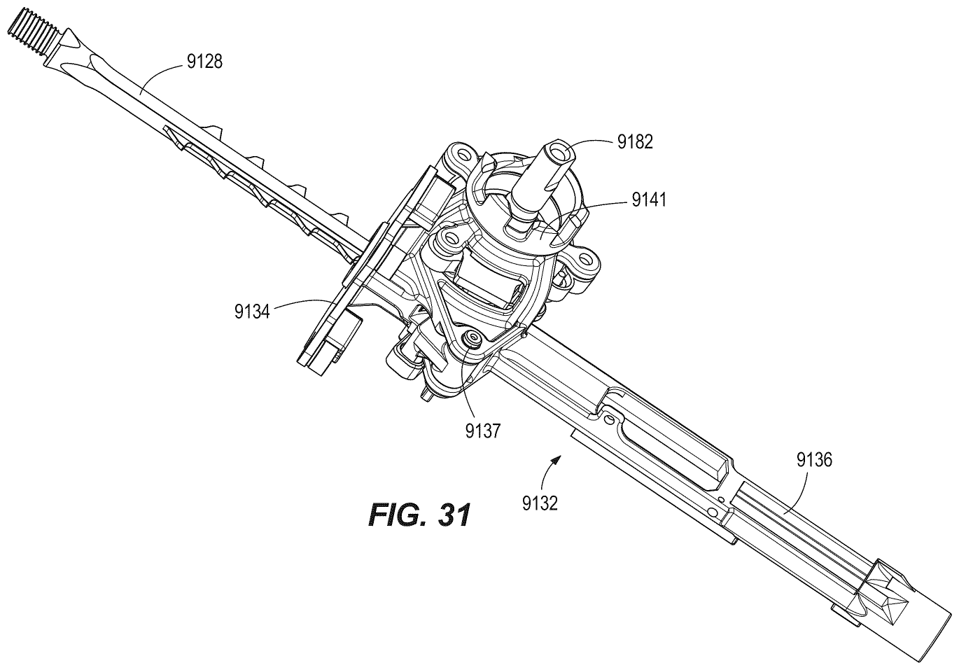

FIGS. 30-31 illustrate another embodiment of a fastener driver 9100 in accordance with the present disclosure, with like parts having like reference numbers plus “9000” and the following differences explained below. Rather than the rotary lifter 148 including an integrated, cantilevered support shaft 182 to support the rotary lifter 148 and to receive torque from the transmission 152, the rotary lifter 9148 is supported by an integrated frame 9132 of the powered fastener driver 9100 and includes a non-integrated support shaft 9182. The integrated frame 9132 combines the frame 9132 and nosepiece 9136 into a single part. The rotary lifter 9148 is rotatably driven by the support shaft 9182 that receives torque from the transmission 152 coupled to the motor 144. The integrated frame 9132 includes an upper flange 9134 to which the inner and outer cylinders 9120, 9140 are coupled (e.g., using fasteners), and the nosepiece 9136 for guiding each fastener as the fastener is driven into the workpiece by the driver blade 9128 (FIG. 31).

With continued reference to FIGS. 30 and 31, the integrated frame 9132 further includes a support arm 9137 that partially receives the support shaft 9182 via an aperture 9139. In some embodiments, the aperture 9139 includes a needle roller bearing (e.g., the bearing assembly 242) to rotatably support the rotary lifter 9148 on the integrated frame 9132. On an opposite side of the support arm 9137, the integrated frame 9132 includes a transmission support 9141 for supporting part of the transmission 152.

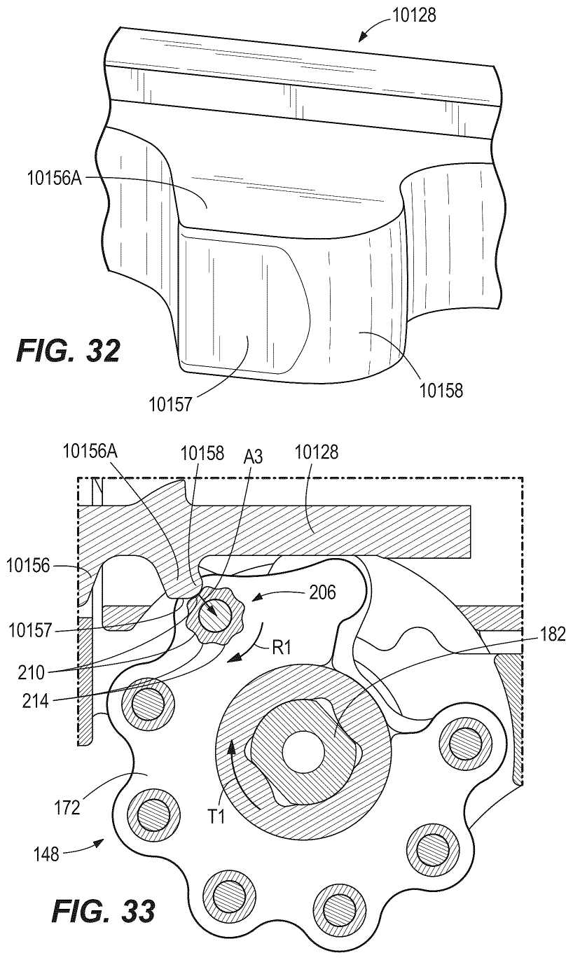

FIGS. 32-36 illustrate another embodiment of a driver blade 10128 in accordance with the present disclosure for use with the rotary lifter 148 (FIG. 33), with like parts having like reference numbers plus the number “10000” and the following differences explained below. In the illustrated embodiment, the support shaft 182 is rotatably coupled to the body 172 of the rotary lifter 148 allowing for relative rotation therebetween, rather than being integrally formed with the body 172 like the rotary lifter 148 in the embodiment disclosed in FIG. 5. Therefore, the support shaft 182 is operatively coupled to the transmission 152 to receive torque therefrom.

In the illustrated embodiment, the driver blade 10128 includes a plurality of lift teeth 10156 extending laterally therefrom to selectively engage with the rotary lifter 148. A lowermost tooth 10156A of one of the plurality of teeth 10156 includes a flat portion 10157 and a rounded portion 10158 that are each configured for selective engagement with the socket roller 206 (FIG. 33) of the rotary lifter 148. In particular, the flat portion 10157 is formed for engagement with any one of the plurality of radial protrusions 214 on the socket roller 206 instead of the engagement sections 210. In contrast, the rounded portion 10158 is formed for engagement with any one of the engagement sections 210.

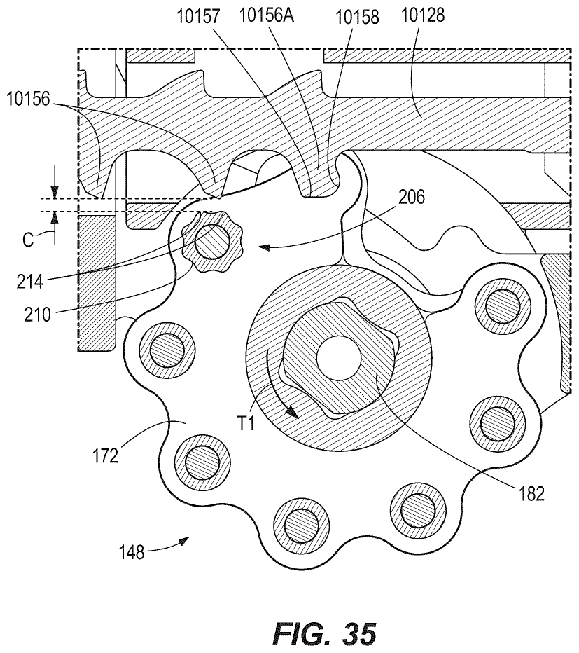

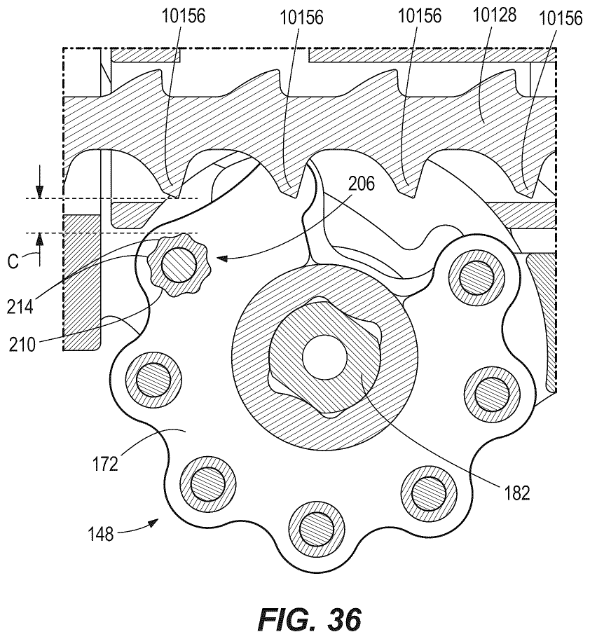

With continued reference to FIGS. 32-36, the rotary lifter 148 is movable relative to the support shaft 182 between a first position (FIG. 33), in which the last tooth 10156A is engaged with one of the engagement portions 210 of the socket roller 206, and a second position (FIGS. 35 and 36), in which the rotary lifter 148 is rotated about the support shaft 182 such that the last tooth 10156A is not engaged with the socket roller 206 and the tooth 10156 adjacent the last tooth 10156A does not contact the socket roller 206. The lifter 148 is in the first position relative to the support shaft 182 when returning the driver blade 10128 from the BDC position toward the TDC position. The lifter 148 rotates (in a counterclockwise direction from the frame of reference of FIG. 33) to the second position after the driver blade 10128 reaches the TDC position and begins movement to the BDC position.

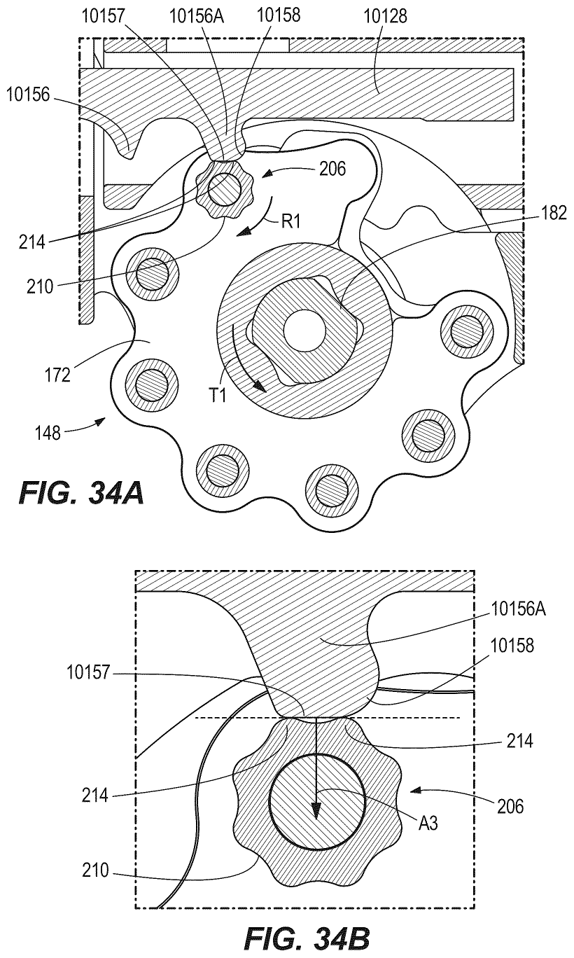

More specifically, as the driver blade 10128 approaches the TDC position, a contact normal A3 to a line tangent to both the rounded portion 10158 of the last tooth 10156A and one of the engagement portions 210 on the socket roller 206 is formed. A reaction force is applied to the rotary lifter 148 along the contact normal A3, which is oriented along a line of action located below the rotational axis of the lifter 148. Thus, a reaction torque T1 is applied to the lifter 148 in a clockwise direction (from the frame of reference of FIG. 33), thereby maintaining the lifter 148 in the first position as the driver blade 10128 is moved toward the TDC position. Simultaneously, the socket roller 206 rotates about its rotational axis R1 in a clockwise direction (from the frame of reference of FIG. 33) while the socket roller 206 maintains contact with the last tooth 10156A, thereby causing the socket roller 206 to rotate to an intermediate position (FIG. 34A-B).

With reference to FIGS. 34A-B, when the socket roller 206 rotates to the intermediate position, the rounded portion 10158 of the last tooth 10156A is no longer in contact with one of the engagement portions 210 of the socket roller 206. Instead, the flat portion 10157 of the last tooth 10156A moves into engagement with two of the plurality of radial protrusions 214 to form the contact normal A3. The line of action of the contact normal A3 remains below the rotational axis of the lifter 148 until the lifter 148 reaches the TDC position. Thereafter, the contact normal A3 (FIG. 34B) between the flat portion 10157 of the last tooth 10156A and two of the radial protrusions 214 of the socket roller 206 changes direction such that the line of action is located above the rotational axis of the lifter 148. Thus, the reaction torque T1 exerted on the lifter 148 by the driver blade 10128 is redirected in a counterclockwise direction (from the frame of reference of FIG. 34A), thereby causing the lifter 148 to pivot away from engagement with the last tooth 10156A of the driver blade 10128 from the first position shown in FIG. 33 to the second position shown in FIGS. 35 and 36.

With reference to FIGS. 35 and 36, when the lifter 148 is in the second position a clearance C (FIG. 36) between the teeth 10156 of the driver blade 10128 and the socket roller 206 is formed. The clearance C allows the teeth 10156 of the driver blade 10128 to pass by the socket 206 without contacting the socket 206 as the driver blade 10128 moves to the TDC position.

With continued reference to FIGS. 35 and 36, when the lifter 148 is in the second position (FIG. 36), and the clearance C is formed such that there is no contact between the socket roller 206 and the driver blade 10128, there is no longer any reaction torque imparted on the lifter 148 by the driver blade 10128. Therefore, the lifter 148 remains in the second position as the driver blade 10128 is moved toward the BDC position until the lifter 148 is rotated back toward contact with the driver blade 10128 by the rotational torque applied to the lifter 148 by the motor 144.

By utilizing the flat portion 10157 on the lowermost tooth 10156A to contact two of the plurality of radial protrusions 214 on the socket roller 206, the lifter 148 is able to rotate further about the support shaft 182, and further away from the driver blade 10128, as compared to other fastener drivers. This configuration is particularly advantageous to prevent subsequent teeth 10156 of the driver blade 10128 from striking and damaging the socket roller 206 as the driver blade 10128 is traveling from the TDC position to the BDC position.

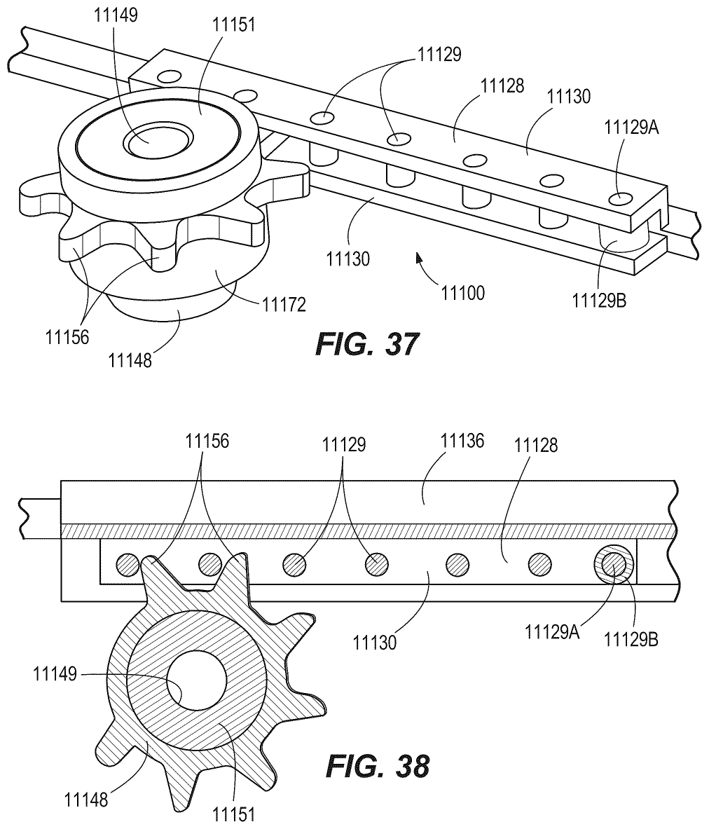

FIGS. 37-38 illustrate another embodiment of a fastener driver 11100 in accordance with the present disclosure, with like parts having like reference numbers plus “11000” and the following differences explained below. The fastener driver 11000 includes a driver blade 11128 movable within a nosepiece 11136 between the BDC position and the TDC position. The driver blade 11128 includes a plurality of pins 11129 supported between two opposing plates 11130. A lowermost pin 11129A of the plurality of pins 11129 includes a roller 11129B. In some embodiments, any of the other pins 11129 can include like rollers 11129B besides the lowermost pin 11129A. The fastener driver 11100 further includes a rotary lifter 11148 defining a body 11172 having a plurality of teeth 11156 radially disposed about the body 11172 and integrally formed therewith for selective engagement with the plurality of pins 11129 on the driver blade 11128. The rotary lifter 11148 further includes an aperture 11149 for partially receiving the support shaft 182, and a bearing assembly 11151 for rotationally supporting the support shaft 182. In some embodiments, the rotary lifter 11148 receives torque from the transmission 11152 via the support shaft 182. In other embodiments, like the rotary lifter 2148, the rotary lifter 11148 can be directly coupled to the transmission 11152 via a splined connection for receiving torque therefrom. In yet other embodiments, like the rotary lifter 3148, the rotary lifter 11148 can be directly coupled to the transmission via a plurality of protrusions extending from the body 11172 of the lifter that rotatably support planet gears of the transmission 11152 to receive torque therefrom.

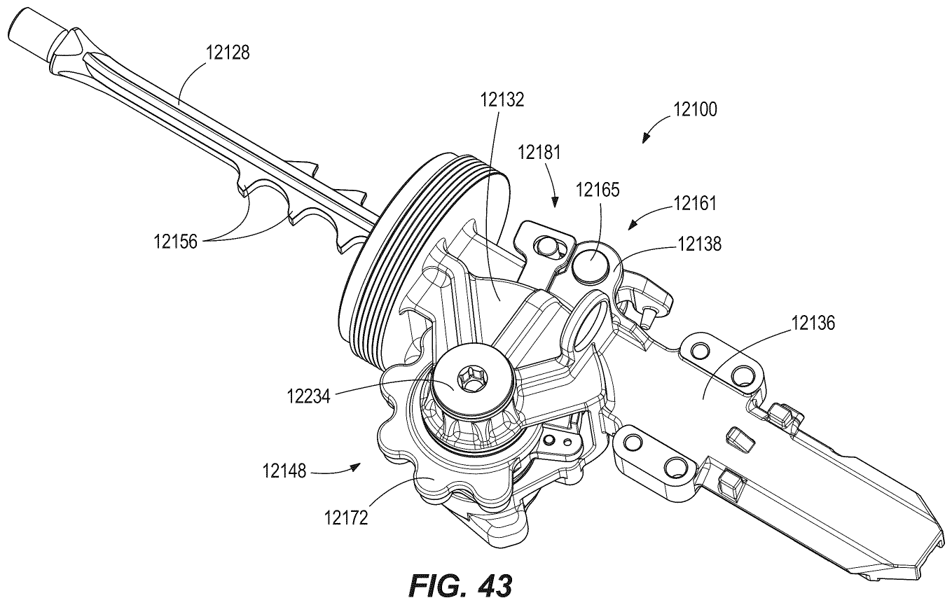

FIGS. 43-45 illustrate another embodiment of a fastener driver 12100 in accordance with the present disclosure, with like parts having reference numbers plus “12000” and the following differences explained below. Like the fastener driver 2100, the rotary lifter 12148 is supported by the frame 12132 of the powered fastener driver 12100 and does not include a support shaft. In the illustrated embodiment, the rotary lifter 12148 is supported by the nosepiece 12136. In other embodiments, the frame 12132 and the nosepiece 12136 can be integrated as a single piece. The nosepiece 12136 includes a non-rotating mounting shaft 12234 extending therefrom to support the rotary lifter 12148. In other embodiments, the non-rotating mounting shaft 12234 may be coupled to and extend from the frame 12132, on which the inner 12120 and outer cylinders 12140 are supported. The rotary lifter 12148 includes a body 12172 having one side coupled to the non-rotating mounting shaft 12234 and an opposite side that is directly coupled to the transmission 12152 to receive torque therefrom.

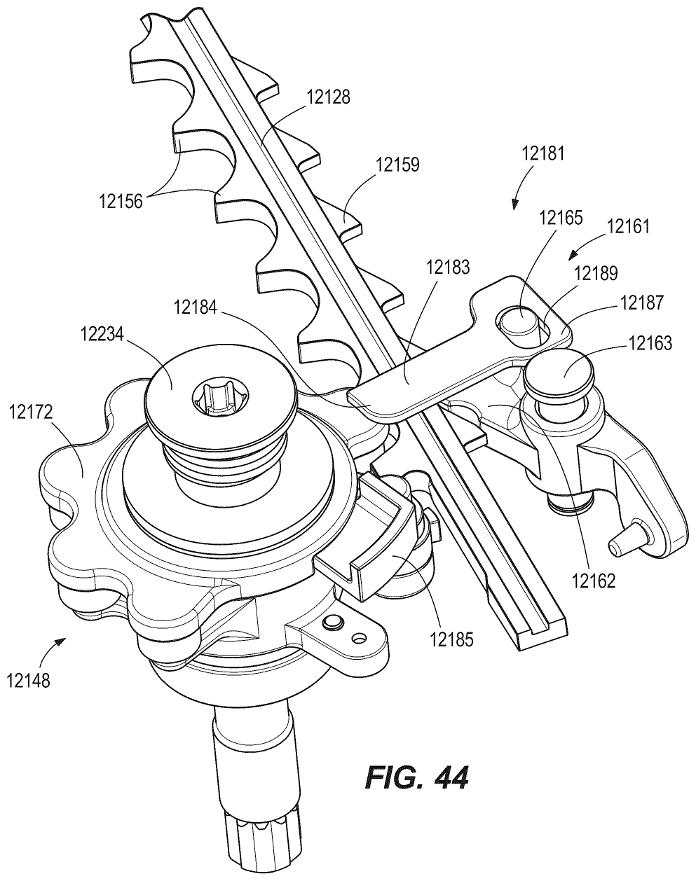

The fastener driver 12100 further includes a driver blade 12128 having a plurality of lift teeth 12156, and a latch assembly 12161 (FIG. 44) having a pawl or latch 12162 for selectively holding the driver blade 12128 in an intermediate location located between the BDC position and the ready position against a biasing force (i.e., the pressurize gas in the compression chamber 142) to allow the user, for example, to clear a jam, etc. The intermediate position may be any position at which the driver blade 12128 stops between the BDC position and the ready position. A separate actuator 12181, as discussed further below, is provided for releasing the latch assembly 12161 from the driver blade 12128. In other words, the latch assembly 12161 is moveable between a latched state in which the driver blade 12128 is held in the intermediate position (e.g., for clearing a jam, etc.), and a released state in which the driver blade 12128 is permitted to be driven by the biasing force toward the driven position.

With continued reference to FIGS. 43-35, the latch 12162 is supported by a support portion 12138 of the nosepiece 12136. More specifically, the latch 12162 is rotatable about a pivot axis defined by a shaft 12163 of the latch assembly 12161. The latch 12162 also includes a protrusion 12165 extending therefrom, as discussed further below.

The latch 12162 is moveable between a latched position (coinciding with the latched state of the latch assembly 12161) in which the latch 12162 is engaged with one of a plurality of projections 12159 on the driver blade 12128 for holding the driver blade 12128 in the intermediate position, and a released position (coinciding with the released state of the latch assembly 12161) in which the latch 12162 is moveable away from the driver blade 12128 to permit the driver blade 12128 to be driven by the gas spring from the intermediate position to the driven position.

FIGS. 43-45 also illustrate an actuator assembly 12181 of the latch assembly 12161 for selectively releasing the latch 12162 from the driver blade 12128. The actuator assembly 12181 is integrated with the lifting assembly 12116 for selectively moving the latch 12162 from the latched position to the released position. In some embodiments, the latch assembly 12161 is manually operated by the actuator assembly 12181. The actuator assembly 12181 includes an actuator member 12183 and a cam member 12185. The actuator member 12183 defines a main body including a first end 12184 and a second end 12187. The main body defines an elongated slot 12189 for receiving the protrusion 12165 on the latch 12162. The cam member 12185 is coupled for co-rotation with the lifter 12148 for selective engagement with the first end 12184 of the actuator member 12183 for moving the actuator member 12183, and thereby the latch 12162, from the latched position to the released position. The actuator assembly 12181 further includes a biasing member (e.g. a spring; not shown) configured to bias the actuator member 12183 into engagement with the cam member 12185.

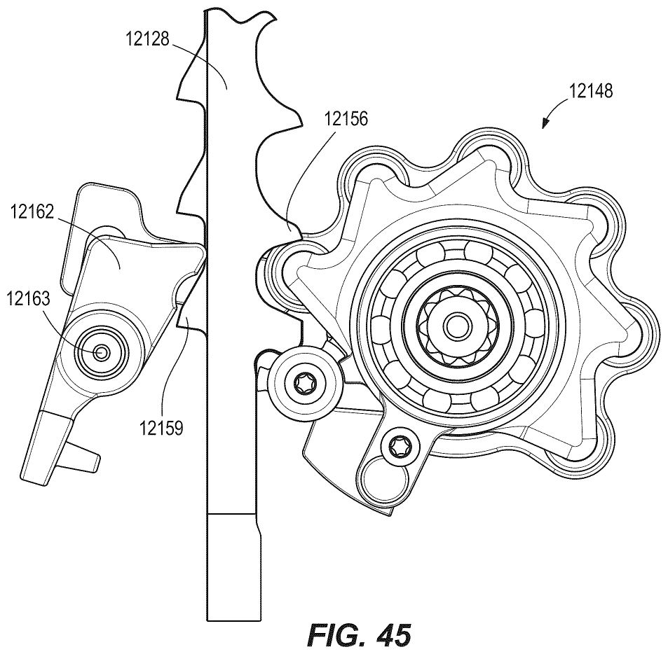

In operation, when the lifter 12148 is returning the driver blade 12128 toward the TDC position, the biasing member is configured to bias the actuator member 12183 toward the lifter 12148, and the protrusion 12165 is positioned toward one end of the elongated slot 12189, thereby positioning the latch 12162 in the latched position (not shown) where the latch 12162 is in contact with one of the plurality of projections 12159 on the driver blade 12128. As the driver blade 12182 approaches the TDC position, the cam member 12185 engages the actuator member 12183 to move the actuator member 12183 away from the lifter 12148 and pivot the latch 12162 about the shaft 12163 from the latched position (FIG. 45) toward the released position. During this movement, the elongated slot 12189 moves relative to the protrusion 12165 with the movement of the actuator member 12183, to locate the protrusion 12165 closer to an opposite side of the elongated slot 12189.

Although the disclosure has described in detail certain preferred embodiments. variations and modifications exist within the scope and spirit of one or more independent aspects of the invention as described.

Various features of the invention are set forth in the following claims.

1. A powered fastener driver comprising:
a driver blade movable from a top-dead-center (TDC) position toward a driven or bottom-dead-center (BDC) position for driving a fastener into a workpiece;
a nosepiece through which the fastener is driven into the workpiece, the nosepiece configured to guide the driver blade and the fastener as the driver blade drives the fastener into the workpiece,
a lifting assembly for providing torque to move the driver blade from the (BDC) position toward the TDC position, the lifting assembly including a rotary lifter configured to selectively engage the driver blade to move the driver blade toward the (TDC) position, the rotary lifter including
a body having a central aperture, and
a flange radially extending from the body that defines an outer radial profile configured to contact the driver blade to return the driver blade from the BDC position toward the TDC position; and
a non-rotating mounting shaft coupled to the central aperture to rotatably support the rotary lifter thereon.

2. The powered fastener driver of claim 1, wherein the lifting assembly further comprises a transmission configured to provide torque to the rotary lifter.

3. The powered fastener driver of claim 2, wherein the body is directly coupled to the transmission.

4. The powered fastener driver of claim 1, wherein the non-rotating mounting shaft extends from the nosepiece of the powered fastener driver.

5. The powered fastener driver of claim 1, further comprising a frame for supporting the lifting assembly, and wherein the non-rotating mounting shaft is coupled to and extends from the frame.

6. The powered fastener driver of claim 5, wherein the non-rotating mounting shaft is coupled to the central aperture via a bearing assembly to rotatably couple the body to the frame.

7. The powered fastener driver of claim 1, wherein the rotary lifter further includes a plurality of pins disposed about the body.

8. The powered fastener driver of claim 7, wherein the rotary lifter further includes a plurality of rollers supported by the respective pins for contacting the driver blade.

9. The powered fastener driver of claim 8, wherein the each of the plurality of pins extend from the flange.

10. The powered fastener driver of claim 9, wherein, together, the plurality of pins and the plurality of rollers define the outer radial profile of the flange.

11. The powered fastener driver of claim 2, wherein the body is splined to the transmission to receive torque therefrom.

12. The powered fastener driver of claim 5, further comprising:
a housing for supporting the frame,
an outer cylinder, and
an inner cylinder within the outer cylinder.

13. The powered fastener driver of claim 12, wherein the outer cylinder is integrally formed with the frame.

14. The powered fastener driver of claim 1, further comprising:
a shaft extending through the nosepiece that defines a pivot axis, and
a latch pivotably supported upon the shaft, the latch selectively holding the driver blade in an intermediate location located between the BDC position and at or near the TDC position against a biasing force.

15. The powered fastener driver of claim 14, wherein the latch is pivoted about the pivot axis between a latched position in which the latch is engaged with the driver blade to hold the driver blade in the intermediate location, and a released position in which the latch is pivoted away from the driver blade to permit the driver blade to move.

16. The powered fastener driver of claim 14, further comprising an actuator assembly for selectively releasing the latch from the driver blade in the intermediate location, the actuator assembly including an actuator member, a cam coupled to the rotary lifter for co-rotation with the rotary lifter, and a biasing member for biasing the actuator member into engagement with the cam.

17. The powered fastener driver of claim 16, wherein, when the cam engages the actuator member, the latch is pivoted about the pivot axis and out of engagement with the driver blade.

18. A powered fastener driver comprising:
a driver blade movable from a top-dead-center (TDC) position toward a driven or bottom-dead-center (BDC) position for driving a fastener into a workpiece;
a nosepiece through which the fastener is driven into the workpiece, the nosepiece configured to guide the driver blade and the fastener as the driver blade drives the fastener into the workpiece;
a lifting assembly for providing torque to move the driver blade from the (BDC) position toward the TDC position, the lifting assembly including a rotary lifter configured to selectively engage the driver blade to move the driver blade toward the (TDC) position, the rotary lifter including
a body having a central aperture, and
a flange radially extending from the body that defines an outer radial profile configured to contact the driver blade to return the driver blade from the BDC position toward the TDC position, the flange including a plurality of rollers radially disposed about the body to define the outer radial profile; and
a non-rotating mounting shaft coupled to the central aperture to rotatably support the rotary lifter thereon;
wherein a last roller of the plurality of rollers is shaped differently than a remainder of the plurality of rollers.

19. The powered fastener driver of claim 18, further comprising a frame for supporting the lifting assembly that is integrally formed with the nosepiece.

20. The powered fastener driver of claim 19, wherein the frame includes an upper flange, and wherein the upper flange supports an inner cylinder and an outer cylinder.

21.-58. (canceled)
